(19) United States
(12) Patent Application Publication
(10) Pub. No.: US 2026/0202685 A1
(43) Pub. Date: Jul. 16, 2026

(54) Tunable Lens with Actuators

(71) Applicant: Apple Inc., Cupertino, CA (US)

(72) Inventors: Daniel J. Burbridge, Cambridge (GB); James E. Pedder, Oxon (GB); Richard J. Topliss, Cambridge (GB); Thomas M. Gregory, Cambridgeshire (GB); Oliver Hart, Cambridge (GB); Roman Patscheider, Winterthur (CH)

(21) Appl. No.: 19/413,670

(22) Filed: Dec. 9, 2025

Related U.S. Application Data
(60) Provisional application No. 63/830,973, filed on Jun. 26, 2025.
(60) Provisional application No. 63/743,767, filed on Jan. 10, 2025.

(51) Int. Cl. G02C 7/08; G02B 27/01; G02C 5/00

(52) U.S. Cl. CPC G02C 7/085; G02B 27/0172; G02C 5/008; G02C 7/086; G02B 2027/0178; G02C 2200/10; G02C 2202/16

(57) ABSTRACT

A head-mounted device may have a lens module with a tunable lens. The tunable lens may include a lens element and one or more actuators that control the shape of the lens element. The actuators may be locally controlled or globally controlled. The actuators may be globally controlled by a common shape memory alloy wire. The common shape memory alloy wire may be wrapped around a pulley system and/or routed about a suitable portion of the head-mounted device. Each actuator may include one or more wedge-shaped structures. Each actuator may include a flexure that is attached between a chassis and a lens shaping element. Each actuator may include a pivot assembly and a brake assembly.

This application claims the benefit of U.S. provisional patent application No. 63/830,973, filed June 26, 2025, and U.S. provisional patent application No. 63/743,767, filed January 10, 2025, which are hereby incorporated by reference herein in their entireties.

### BACKGROUND

This relates generally to electronic devices and, more particularly, to wearable electronic device systems.

Electronic devices are sometimes configured to be worn by users. For example, head-mounted devices are provided with head-mounted structures that allow the devices to be worn on users’ heads. The head-mounted devices may include optical systems with lenses. The lenses allow displays in the devices to present visual content to users.

Head-mounted devices typically include lenses with fixed shapes and properties. If care is not taken, it may be difficult to adjust these types of lenses to optimally present content to each user of the head-mounted device.

### SUMMARY

A tunable lens may include a lens element having a periphery, a lens shaping element attached to the periphery of the lens element, and a plurality of actuators distributed around the periphery. Each actuator in the plurality of actuators may be configured to adjust a position of the lens shaping element in a first direction, each actuator in the plurality of actuators may include a wedge-shaped structure that is configured to move along a second direction that is orthogonal to the first direction, and the wedge-shaped structure of each one of the plurality of actuators may be controlled by a common wire.

A tunable lens may include a lens element having a periphery, a lens shaping element attached to the periphery of the lens element, and a rotating ring having a plurality of recesses distributed around the periphery. The rotating ring may be configured to rotate along a first direction, each one of the plurality of recesses may be configured to adjust a position of the lens shaping element in a second direction that is orthogonal to the first direction, and at least two of the plurality of recesses may have different shapes.

A tunable lens may include a lens element having a periphery, a lens shaping element attached to the periphery of the lens element, a chassis, and flexures distributed around the periphery. Each flexure may have first and second opposing ends. The first end of each flexure may be attached to the chassis and the second end of each flexure may be attached to the lens shaping element. The tunable lens may include a common wire that is configured to displace the second ends of the flexures along a first direction and the displacement of the second ends of the flexures along the first direction may cause displacement of the second ends of the flexures along a second direction that is orthogonal to the first direction.

A head-mounted device may include a frame including a nose bridge, a temple coupled to the frame, and a tunable lens in the frame. The tunable lens may include a lens element having a periphery, a lens shaping element attached to the periphery of the lens element, and a plurality of actuators distributed around the periphery. Each actuator in the plurality of actuators may be configured to adjust a position of the lens shaping element in a first direction, each actuator in the plurality of actuators may include a wedge-shaped structure that is configured to move along a second direction that is orthogonal to the first direction, and the wedge-shaped structure of each one of the plurality of actuators may be controlled by a common wire.

### BRIEF DESCRIPTION OF THE DRAWINGS

FIG. 1 is a schematic diagram of an illustrative electronic device such as a head-mounted display device in accordance with some embodiments.

FIG. 2 is a top view of an illustrative head-mounted device in accordance with some embodiments.

FIG. 3 is a cross-sectional side view of an illustrative lens module with first and second lens elements in accordance with some embodiments.

FIGS. 4 and 5 are cross-sectional side views of an illustrative fluid-filled lens element in accordance with some embodiments.

FIG. 6 is a top view of an illustrative tunable lens with a lens shaping structure in accordance with some embodiments.

FIGS. 7A and 7B are cross-sectional side views of an illustrative actuator with wedge-shaped structures that are displaced horizontally to vertically displace a lens shaping element in accordance with some embodiments.

FIG. 8A is a top view of an illustrative tunable lens with locally controlled actuators in accordance with some embodiments.

FIG. 8B is a top view of an illustrative tunable lens with globally controlled actuators where a common SMA wire is connected to each actuator in accordance with some embodiments.

FIG. 8C is a top view of an illustrative tunable lens with globally controlled actuators where a common SMA wire is connected to one actuator and the remaining actuators are passively connected to the one actuator in accordance with some embodiments.

FIG. 9 is a cross-sectional side view of an illustrative tunable lens with actuators having wedge-shaped structures of different shapes in accordance with some embodiments.

FIG. 10 is a top view of an illustrative tunable lens with wire redirecting structures in accordance with some embodiments.

FIG. 11A is a top view of an illustrative flexure on the acute side of a bend in a shape memory alloy (SMA) wire in accordance with some embodiments.

FIG. 11B is a top view of an illustrative flexure on the obtuse side of a bend in an SMA wire in accordance with some embodiments.

FIG. 11C is a top view of an illustrative bearing on the acute side of a bend in an SMA wire in accordance with some embodiments.

FIG. 11D is a top view of an illustrative pulley on the acute side of a bend in an SMA wire in accordance with some embodiments.

FIG. 11E is a top view of an illustrative crimp used to bend an SMA wire in accordance with some embodiments.

FIG. 11F is a side view of the illustrative crimp of FIG. 11E in accordance with some embodiments.

FIG. 12 is a cross-sectional side view of an illustrative tunable lens with an actuator of the type shown in FIGS. 7A and 7B in accordance with some embodiments.

FIG. 13 is a cross-sectional side view of an illustrative tunable lens with globally controlled cam structures having slots in accordance with some embodiments.

FIGS. 14A and 14B are cross-sectional side views of an illustrative actuator with a cam structure having rounded edges and shape memory alloy wires on opposite sides of the cam structure in accordance with some embodiments.

FIGS. 15A and 15B are cross-sectional side views of an illustrative actuator with a cam structure having rounded edges and shape memory alloy wires on the same side of the cam structure in accordance with some embodiments.

FIGS. 16A and 16B are cross-sectional side views of an illustrative tunable lens with a rotating ring having recesses that vertically displace a lens shaping element with integral protrusions in accordance with some embodiments.

FIG. 17 is a cross-sectional side view of an illustrative tunable lens with a lens shaping element attached to a ring with protrusions in accordance with some embodiments.

FIG. 18 is a top view of an illustrative tunable lens with a rotating ring and set screws in accordance with some embodiments.

FIG. 19 is a cross-sectional side view of an illustrative tunable lens with a rotating ring having a recess that is defined by a curved surface and that includes a ball bearing in accordance with some embodiments.

FIG. 20A is a top view of an illustrative tunable lens with a rotating ring that directly overlaps a lens shaping element without tabs in accordance with some embodiments.

FIG. 20B is a top view of an illustrative tunable lens with a rotating ring that directly overlaps tabs of a lens shaping element in accordance with some embodiments.

FIG. 21 is a top view of an illustrative tunable lens with inner and outer rotating rings that rotate in opposite directions in accordance with some embodiments.

FIG. 22 is a cross-sectional side view of the illustrative tunable lens of FIG. 21 in accordance with some embodiments.

FIG. 23 is a top view of an illustrative tunable lens with flexures attached to a common ring in accordance with some embodiments.

FIG. 24 is a cross-sectional side view of the illustrative tunable lens of FIG. 23 in accordance with some embodiments.

FIG. 25 is a top view of an illustrative tunable lens with linkages in accordance with some embodiments.

FIG. 26 is a cross-sectional side view of the illustrative tunable lens of FIG. 25 in accordance with some embodiments.

FIGS. 27 and 28 are cross-sectional side views of an illustrative actuator that comprises a pivot assembly and a brake assembly in accordance with some embodiments.

FIG. 29 is a top view of an illustrative tunable lens that includes actuators of the type shown in FIGS. 27 and 28 in accordance with some embodiments.

FIG. 30 is a schematic diagram of an illustrative pulley system that may be used to route a shape memory alloy wire in accordance with some embodiments.

FIG. 31 is a perspective view of an illustrative head-mounted device with a shape memory alloy wire pulley system in a side of the housing in accordance with some embodiments.

FIG. 32 is a perspective view of an illustrative head-mounted device with a shape memory alloy wire that extends over a nose bridge in accordance with some embodiments.

### DETAILED DESCRIPTION

Electronic devices may include displays and other components for presenting content to users. The electronic devices may be wearable electronic devices. A wearable electronic device such as a head-mounted device may have head-mounted support structures that allow the head-mounted device to be worn on a user’s head.

A head-mounted device may contain a display formed from one or more display panels (displays) for displaying visual content to a user. A lens system may be used to allow the user to focus on the display and view the visual content. The lens system may have a left lens module that is aligned with a user’s left eye and a right lens module that is aligned with a user’s right eye.

In some cases, the user may wish to view real-world content rather than a display. The user may require different optical prescriptions depending on the distance to an object, the degree to which the user’s eyes are verging (which may be predictable based on the distance to the object viewed), lighting conditions, and/or other factors. The head-mounted device may contain lenses disposed in such a way as the real-world content is viewable through the lens system.

The lens modules in the head-mounted device may include lenses that are adjustable. For example, fluid-filled adjustable lenses may be adjusted for specific viewers.

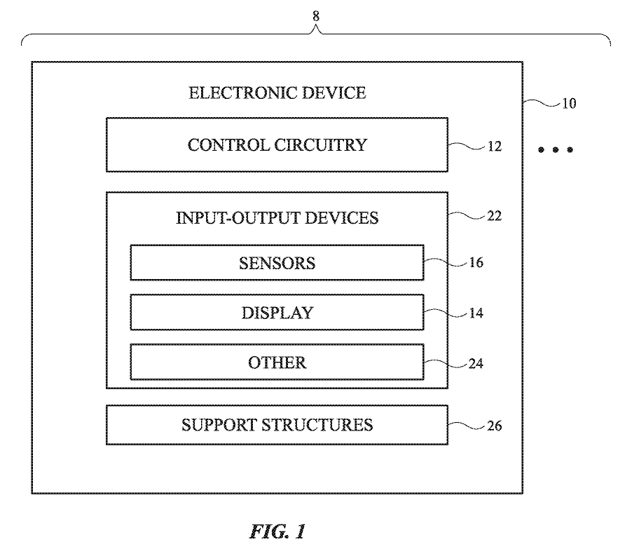

A schematic diagram of an illustrative system having an electronic device with a lens module is shown in FIG. 1. As shown in FIG. 1, system 8 may include one or more electronic devices such as electronic device 10. The electronic devices of system 8 may include computers, cellular telephones, head-mounted devices, wristwatch devices, and other electronic devices. Configurations in which electronic device 10 is a head-mounted device are sometimes described herein as an example.

As shown in FIG. 1, electronic devices such as electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involved in processing three-dimensional facial image data, operations involving the adjustment of components using control signals, etc.). Control circuitry 12 may include wired and wireless communications circuitry. For example, control circuitry 12 may include radio-frequency transceiver circuitry such as cellular telephone transceiver circuitry, wireless local area network (WiFi®) transceiver circuitry, millimeter wave transceiver circuitry, and/or other wireless communications circuitry.

During operation, the communications circuitry of the devices in system 8 (e.g., the communications circuitry of control circuitry 12 of device 10), may be used to support communication between the electronic devices. For example, one electronic device may transmit video and/or audio data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Device 10 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 1, input-output devices 22 may include one or more displays such as display 14. Display 14 may be used to display images for a user of head-mounted device 10. Display 14 may be a transparent or translucent display so that a user may observe physical objects through the display while computer-generated content is overlaid on top of the physical objects by presenting computer-generated images on the display. A transparent or translucent display may be formed from a transparent or translucent pixel array (e.g., a transparent organic light-emitting diode display panel) or may be formed by a display device that provides images to a user through a transparent structure such as a beam splitter, holographic coupler, or other optical coupler (e.g., a display device such as a liquid crystal on silicon display). Alternatively, display 14 may be an opaque display that blocks light from physical objects when a user operates head-mounted device 10. In this type of arrangement, a pass-through camera may be used to display physical objects to the user. The pass-through camera may capture images of the physical environment and the physical environment images may be displayed on the display for viewing by the user. Additional computer-generated content (e.g., text, game-content, other visual content, etc.) may optionally be overlaid over the physical environment images to provide an extended reality environment for the user. When display 14 is opaque, the display may also optionally display entirely computer-generated content (e.g., without displaying images of the physical environment).

Display 14 may include one or more optical systems (e.g., lenses) (sometimes referred to as optical assemblies) that allow a viewer to view images on display(s) 14. A single display 14 may produce images for both eyes or a pair of displays 14 may be used to display images. In configurations with multiple displays (e.g., left and right eye displays), the focal length and positions of the lenses may be selected so that any gap present between the displays will not be visible to a user (e.g., so that the images of the left and right displays overlap or merge seamlessly). Display modules (sometimes referred to as display assemblies) that generate different images for the left and right eyes of the user may be referred to as stereoscopic displays. The stereoscopic displays may be capable of presenting two-dimensional content (e.g., a user notification with text) and three-dimensional content (e.g., a simulation of a physical object such as a cube).

The example of device 10 including a display is merely illustrative and display(s) 14 may be omitted from device 10 if desired. Device 10 may include an optical pass-through area where real-world content is viewable to the user either directly or through a tunable lens.

Displays in device 10 such as display 14 may be organic light-emitting diode displays or other displays based on arrays of light-emitting diodes, liquid crystal displays, liquid-crystal-on-silicon displays, projectors or displays based on projecting light beams on a surface directly or indirectly through specialized optics (e.g., digital micromirror devices), electrophoretic displays, plasma displays, electrowetting displays, or any other suitable displays.

Input-output circuitry 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user’s eyes), touch sensors, buttons, force sensors, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), fingerprint sensors and other biometric sensors, optical position sensors (optical encoders), and/or other position sensors such as linear position sensors, and/or other sensors. Sensors 16 may include proximity sensors (e.g., capacitive proximity sensors, light-based (optical) proximity sensors, ultrasonic proximity sensors, and/or other proximity sensors). Proximity sensors may, for example, be used to sense relative positions between a user’s nose and lens modules in device 10.

User input and other information may be gathered using sensors and other input devices in input-output devices 22. If desired, input-output devices 22 may include other devices 24 such as haptic output devices (e.g., vibrating components), light-emitting diodes and other light sources, speakers such as ear speakers for producing audio output, and other electrical components. Device 10 may include circuits for receiving wireless power, circuits for transmitting power wirelessly to other devices, batteries and other energy storage devices (e.g., capacitors), joysticks, buttons, and/or other components.

Electronic device 10 may have housing structures (e.g., housing walls, straps, etc.), as shown by illustrative support structures 26 of FIG. 1. In configurations in which electronic device 10 is a head-mounted device (e.g., a pair of glasses, goggles, a helmet, a hat, etc.), support structures 26 may include head-mounted support structures (e.g., a helmet housing, head straps, temples in a pair of eyeglasses, goggle housing structures, and/or other head-mounted structures). The head-mounted support structures may be configured to be worn on a head of a user during operation of device 10 and may support display(s) 14, sensors 16, other components 24, other input-output devices 22, and control circuitry 12.

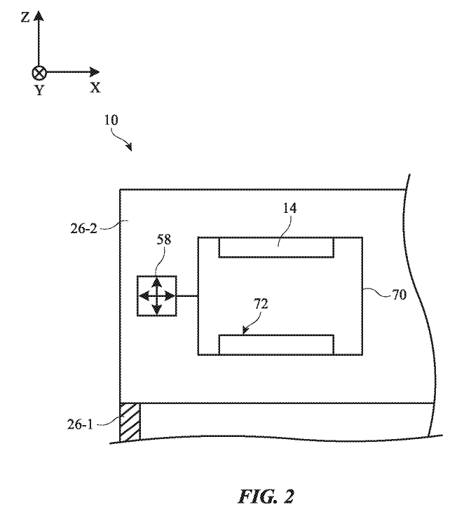

FIG. 2 is a top view of electronic device 10 in an illustrative configuration in which electronic device 10 is a head-mounted device. As shown in FIG. 2, electronic device 10 may include support structures (see, e.g., support structures 26 of FIG. 1) that are used in housing the components of device 10 and mounting device 10 onto a user’s head. These support structures may include, for example, structures that form housing walls and other structures for main unit 26-2 (e.g., exterior housing walls, lens module structures, etc.) and straps or other supplemental support structures such as structures 26-1 that help to hold main unit 26-2 on a user’s face.

The electronic device may include optical modules such as optical module 70. The electronic device may include left and right optical modules that correspond respectively to a user’s left eye and right eye. An optical module corresponding to the user’s left eye is shown in FIG. 2.

Each optical module 70 includes a corresponding lens module 72 (sometimes referred to as lens stack-up 72, lens 72, or adjustable lens 72). Lens 72 may include one or more lens elements arranged along a common axis. Each lens element may have any desired shape and may be formed from any desired material (e.g., with any desired refractive index). The lens elements may have unique shapes and refractive indices that, in combination, focus light (e.g., from a display or from the physical environment) in a desired manner. Each lens element of lens module 72 may be formed from any desired material (e.g., glass, a polymer material such as polycarbonate or acrylic, a crystal such as sapphire, etc.).

Modules 70 may optionally be individually positioned relative to the user’s eyes and relative to some of the housing wall structures of main unit 26-2 using positioning circuitry such as positioner 58. Positioner 58 may include stepper motors, piezoelectric actuators, motors, linear electromagnetic actuators, shape memory alloys (SMAs), and/or other electronic components for adjusting the position of displays, the optical modules 70, and/or lens modules 72. Positioners 58 may be controlled by control circuitry 12 during operation of device 10. For example, positioners 58 may be used to adjust the spacing between modules 70 (and therefore the lens-to-lens spacing between the left and right lenses of modules 70) to match the interpupillary distance IPD of a user’s eyes. In another example, the lens module may include an adjustable lens element. The curvature of the adjustable lens element may be adjusted in real time by positioner(s) 58 to compensate for a user’s eyesight and/or viewing conditions.

Each optical module may optionally include a display such as display 14 in FIG. 2. As previously mentioned, the displays may be omitted from device 10 if desired. In this type of arrangement, the device may still include one or more lens modules 72 (e.g., through which the user views the real world). In this type of arrangement, real-world content may be selectively focused for a user.

FIG. 3 is a cross-sectional side view of an illustrative lens module with multiple lens elements. As shown, lens module 72 includes a first lens element 72-1 and a second lens element 72-2. Each surface of the lens elements may have any desired curvature. For example, each surface may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. A freeform surface may include both convex and concave portions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. In one example, shown in FIG. 3, lens element 72-1 has a convex surface that faces display 14 and an opposing concave surface. Lens element 72-2 has a convex surface that faces lens element 72-1 and an opposing concave surface.

One or both of lens elements 72-1 and 72-2 may be adjustable. In one example, lens element 72-1 is a fixed (e.g., non-adjustable) lens element whereas lens element 72-2 is an adjustable lens element. The adjustable lens element 72-2 may be used to accommodate a user’s eyeglass prescription, for example. The shape of lens element 72-2 may be adjusted if a user’s eyeglass prescription changes (without needing to replace any of the other components within device 10). As another possible use case, a first user with a first eyeglass prescription (or no eyeglass prescription) may use device 10 with lens element 72-2 having a first shape and a second, different user with a second eyeglass prescription may use device 10 with lens element 72-2 having a second shape that is different than the first shape. Lens element 72-2 may have varying lens power and/or may provide varying amount of astigmatism correction to provide prescription correction for the user.

The example of lens module 72 including two lens elements is merely illustrative. In general, lens module 72 may include any desired number of lens elements (e.g., one, two, three, four, more than four, etc.). Any subset or all of the lens elements may optionally be adjustable. Any of the adjustable lens elements in the lens module may optionally be fluid-filled adjustable lenses. Lens module 72 may also include any desired additional optical layers (e.g., partially reflective mirrors that reflect 50% of incident light, linear polarizers, retarders such as quarter wave plates, reflective polarizers, circular polarizers, reflective circular polarizers, etc.) to manipulate light that passes through lens module.

As previously mentioned, one or more of the adjustable lens elements may be a fluid-filled lens element. An example is described herein where lens element 72-2 from FIG. 3 is a fluid-filled lens element. When lens element 72-2 is a fluid-filled lens element, the lens element may include one or more components that define the surfaces of lens element 72-2. These elements may also be referred to a lens elements. In other words, adjustable lens element 72-2 (sometimes referred to as adjustable lens module 72-2) may be formed by multiple respective lens elements.

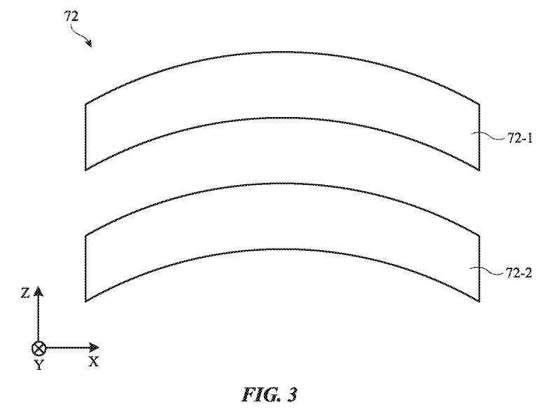

FIG. 4 is a cross-sectional side view of adjustable fluid-filled lens element 72-2. As shown, fluid-filled chamber 82 (sometimes referred to as chamber 82 or fluid chamber 82) that includes fluid 92 is interposed between lens elements 84 and 86. Fluid 92 may be a liquid, gel, or gas with a pre-determined index of refraction (and may therefore sometimes be referred to as liquid 92, gel 92, or gas 92). The fluid may sometimes be referred to as an index-matching oil, an optical oil, an optical fluid, an index-matching material, an index-matching liquid, etc. Lens elements 84 and 86 may have the same index of refraction or may have different indices of refraction. Fluid 92 that fills chamber 82 between lens elements 84 and 86 may have an index of refraction that is the same as the index of refraction of lens element 84 but different from the index of refraction of lens element 86, may have an index of refraction that is the same as the index of refraction of lens element 86 but different from the index of refraction of lens element 84, may have an index of refraction that is the same as the index of refraction of lens element 84 and lens element 86, or may have an index of refraction that is different from the index of refraction of lens element 84 and lens element 86. Lens elements 84 and 86 may have a circular footprint, may have an elliptical footprint, may have or may have a footprint of any another desired shape (e.g., an irregular footprint).

The amount of fluid 92 in chamber 82 may have a constant volume or an adjustable volume. If the amount of fluid is adjustable, the lens module may also include a fluid reservoir and a fluid controlling component (e.g., a pump, stepper motor, piezoelectric actuator, motor, linear electromagnetic actuator, and/or other electronic component that applies a force to the fluid in the fluid reservoir) for selectively transferring fluid between the fluid reservoir and the chamber.

Lens elements 84 and 86 may be transparent lens elements formed from any desired material (e.g., glass, a polymer material such as polycarbonate or acrylic, a crystal such as sapphire, etc.). Each one of lens elements 84 and 86 may be elastomeric, semi-rigid, or rigid. Elastomeric lens elements may be formed from a natural or synthetic polymer that has a low Young’s modulus for high flexibility. For example the elastomeric membrane may be formed from a material having a Young’s modulus of less than 1 GPa, less than 0.5 GPa, less than 0.1 GPa, etc.

Semi-rigid lens elements may be formed from a semi-rigid material that is stiff and solid, but not inflexible. A semi-rigid lens element may, for example, be formed from a thin layer of polymer or glass. Semi-rigid lens elements may be formed from a material having a Young’s modulus that is greater than 1 Gpa, greater than 2 GPa, greater than 3 GPa, greater than 10 GPa, greater than 25 GPa, etc. Semi-rigid lens elements may be formed from polycarbonate, polyethylene terephthalate (PET), polymethylmethacrylate (PMMA), acrylic, glass, or any other desired material. The properties of semi-rigid lens elements may result in the lens element becoming rigid along a first axis when the lens element is curved along a second axis perpendicular to the first axis or, more generally, for the product of the curvature along its two principal axes of curvature to remain roughly constant as it flexes. This is in contrast to an elastomeric lens element, which remains flexible along a first axis even when the lens element is curved along a second axis perpendicular to the first axis. The properties of semi-rigid lens elements may allow the semi-rigid lens elements to form a cylindrical lens with tunable lens power and a tunable axis.

Rigid lens elements may be formed from glass, a polymer material such as polycarbonate or acrylic, a crystal such as sapphire, etc. In general, the rigid lens elements may not deform when pressure is applied to the lens elements within the lens module. In other words, the shape and position of the rigid lens elements may be fixed. Each surface of a rigid lens element may be planar, concave (e.g., spherically, aspherically, or cylindrically concave), or convex (e.g., spherically, aspherically, or cylindrically convex). Rigid lens elements may be formed from a material having a Young’s modulus that is greater than greater than 25 GPa, greater than 30 GPa, greater than 40 GPa, greater than 50 GPa, etc.

One or more structures such as bellows structure 52 (sometimes referred to as wall 52, flexible wall 52, flexible structure 52, etc.) and/or lens housing 80 (sometimes referred to as housing 80, lens chassis 80, chassis 80, support structure 80, etc.) may also define the fluid-filled chamber 82 of lens element 72-2. The bellows structure 52 is sufficiently compliant to permit adjustment to the shape of lens element 84. However, the bellows structure maintains a stable boundary for the fluid 92 inside fluid-filled chamber 82. Lens housing 80 may be a rigid housing structure and may serve as a mechanical ground for tunable lens 72-2.

In addition to lens elements 84 and 86 and fluid-filled chamber 82, lens module 72-2 also includes a lens shaping element 88. Lens shaping element 88 may be coupled to one or more actuators (e.g., positioned around the circumference of the lens module). The lens shaping element 88 may also be coupled to lens element 84. The actuators may be adjusted to position lens shaping element 88 (sometimes referred to as lens shaper 88, deformable lens shaper 88, lens shaping structure 88, lens shaping member 88, annular member 88, ring-shaped structure 88, etc.). The lens shaping element 88 in turn manipulates the positioning/shape of lens element 84. In this way, the curvature of the lens element 84 (and accordingly, the lens power of lens module 72-2) may be adjusted.

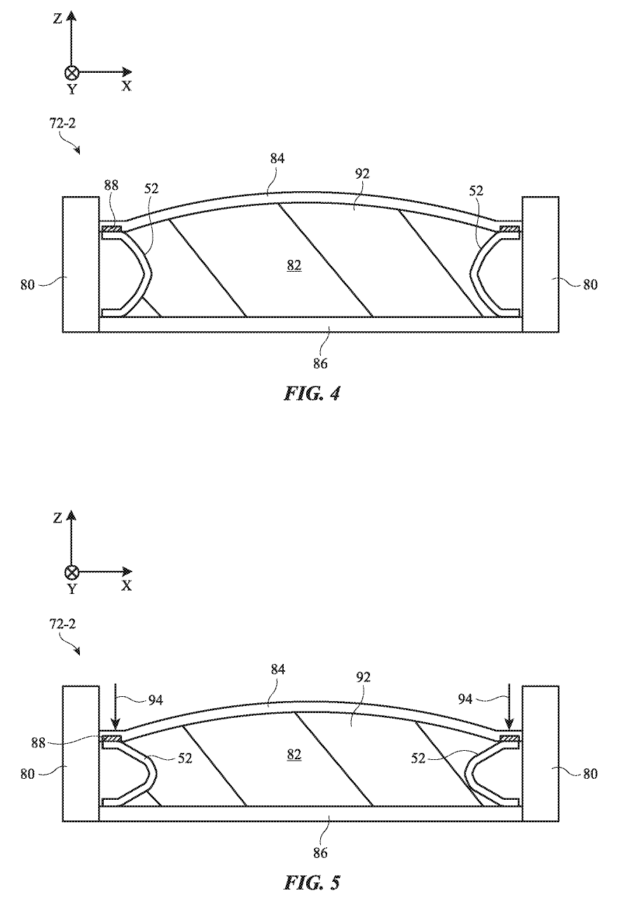

FIG. 5 is a cross-sectional side view of lens element 72-2 showing an illustrative adjustment of the shape of lens element 72-2. As shown, during adjustments of lens element 72-2, lens shaping element 88 (and correspondingly, lens element 84) may be biased in direction 94 at multiple points along its periphery (e.g., a point force is applied in direction 94 at multiple points). In this way, the curvature of the lens element 84 (and accordingly, the lens power of lens element 72-2) may be adjusted. In the example of FIG. 5, lens element 84 has more curvature than in FIG. 4.

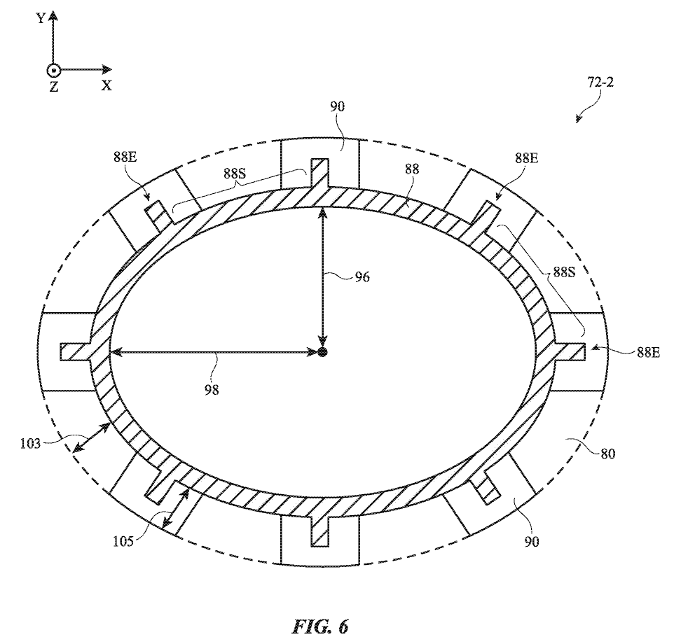

FIG. 6 is a top view of an illustrative lens shaping element 88. As shown, lens shaping element 88 may have an annular or ring shape with the lens shaping element surrounding a central opening. The lens shaping element may have any desired shape. For example, the lens shaping element may be circular, elliptical, or have an irregular shape. In the example of FIG. 6, the lens shaping element has an elliptical shape (e.g., a non-uniform radius around the ring shape). For example, a first distance 96 (e.g., a minimum distance) from the center of the central opening to the edge of the lens shaping element may be smaller than a second distance 98 (e.g., a maximum distance) from the center of the central opening to the edge of the lens shaping element. Distance 96 and 98 may be less than 100 millimeters, less than 60 millimeters, less than 40 millimeters, less than 30 millimeters, greater than 10 millimeters, greater than 20 millimeters, between 10 and 50 millimeters, etc.

Lens shaping element 88 may have a plurality of tabs 88E that extend from the main portion of the lens shaping element. The tabs 88E (sometimes referred to as extensions 88E, actuator points 88E, etc.) may each be coupled to a respective actuator 90 (sometimes referred to as actuation point 90). Each actuator may selectively move its respective extension 88E up and down (e.g., in the Z-direction) to control the position of tab 88E in the Z-direction. In other words, actuator 90 is a linear actuator.

FIG. 6 shows how a plurality of tabs 88E (and corresponding actuators) may be distributed around the perimeter of lens shaping element 88. Tabs 88E may be distributed around lens shaping element 88 in a uniform manner (e.g., with equal spacing between each pair of adjacent tabs 88E) or in a non-uniform manner (e.g., with unequal spacing between at least two of the adjacent tabs 88E).

Between each pair of adjacent tabs 88E, there is a lens shaper segment 88S. In the example of FIG. 6, there are 8 tabs 88E and 8 actuators 90 around the perimeter of lens shaping element 88. This example is merely illustrative. In general, more tabs (and corresponding actuators) allow for greater control of the shape of the lens element (e.g., lens element 84) to which lens shaping element 88 is coupled. Any desired number of tabs and actuators (e.g., one, two, three, four, more than four, more than six, more than eight, more than ten, more than twelve, more than twenty, less than twenty, less than ten, between four and twelve, etc.) may be used depending upon the specific target shapes for the lens element, the target cost/complexity of the lens module, etc.

Lens shaping element 88 may be elastomeric (e.g., a natural or synthetic polymer that has a low Young’s modulus for high flexibility, as discussed above in greater detail) or semi-rigid (e.g., formed from a semi-rigid material that is stiff and solid, but not inflexible, as discussed above in greater detail). A semi-rigid lens shaping element may, for example, be formed from a thin layer of polymer, glass, metal, etc. Because lens shaping element 88 is formed in a ring around the lens module, lens shaping element 88 does not need to be transparent (and therefore may be formed from an opaque material such as metal). The rigidity of lens shaping element 88 may be selected such that the lens shaping element assumes desired target shapes when manipulated by the actuators around its perimeter.

Actuators 90 may be positioned within lens housing 80. Lens housing 80 may optionally define a portion of the fluid-filled chamber 82. Lens housing 80 may have a width 103. Each actuator 90 may have a width 105. In some devices, it may be desirable for the magnitude of width 103 to be small (e.g., to achieve a thin bezel with a target aesthetic appearance). However, the magnitude of width 103 needs to be greater than or equal to the magnitude of width 105 (of actuators 90) to accommodate actuators 90. In other words, the width of the actuators may be a limiting factor in the width of the lens housing.

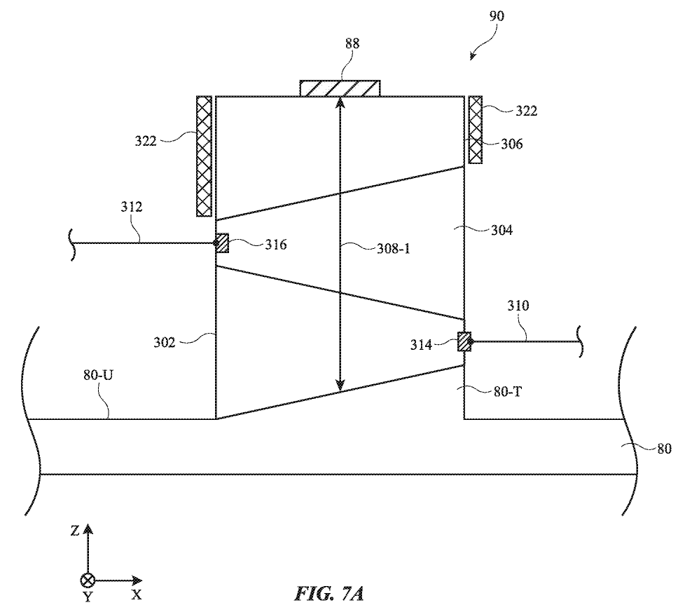

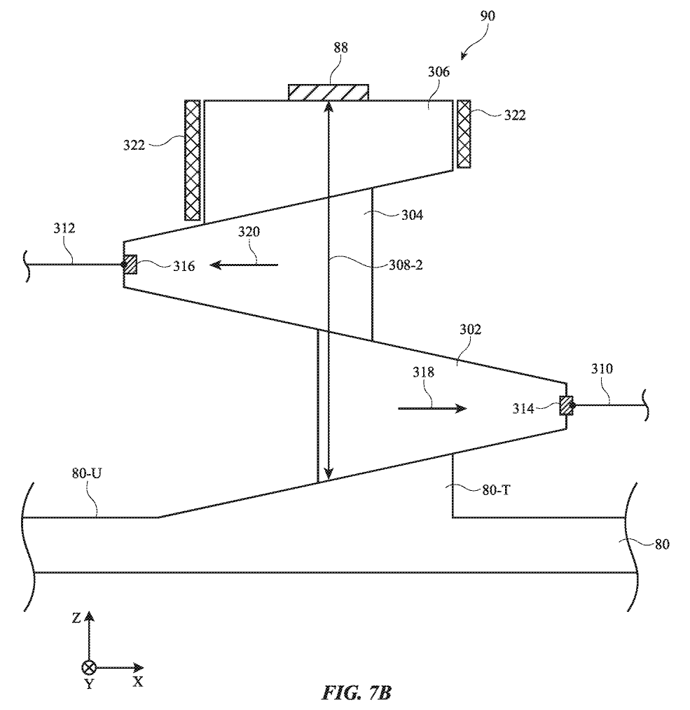

FIGS. 7A and 7B are cross-sectional side views of an illustrative actuator that may be used in a tunable lens. As shown in FIG. 7A, the actuator may include a first wedge-shaped structure 302 and a second wedge-shaped structure 304 that are interposed between a tapered lens housing portion 80-T (sometimes referred to as tapered chassis portion 80-T) and a tapered structure 306. Tapered lens housing portion 80-T may be an integral part of lens housing 80. The tapered lens housing portion 80-T protrudes from the bulk of lens housing 80 (e.g., planar upper surface 80-U) with a tapered surface (e.g., a surface that is sloped relative to the X-axis in FIG. 7A). Wedge-shaped structure 302 has a lower tapered surface that rests on the tapered surface of lens housing portion 80-T. Wedge-shaped structure 302 has an upper tapered surface with a slope in the opposite direction as the lower tapered surface. The lower tapered surface slopes in the positive Z-direction from left to right across the page whereas the upper tapered surface slopes in the negative Z-direction from left to right across the page.

Wedge-shaped structure 304 has a lower tapered surface that rests on the tapered surface of wedge-shaped structure 302. Wedge-shaped structure 304 has an upper tapered surface with a slope in the opposite direction as the lower tapered surface. The lower tapered surface slopes in the negative Z-direction from left to right across the page whereas the upper tapered surface slopes in the positive Z-direction from left to right across the page.

Tapered structure 306 has a lower tapered surface that rests on the upper tapered surface of wedge-shaped structure 304. The lower tapered surface of structure 306 slopes in the positive Z-direction from left to right across the page. Structure 306 has a planar upper surface that is attached to lens shaping element 88. This example is merely illustrative and the upper surface of structure 306 may be non-planar if desired.

Each one of the wedge-shaped structures 302 and 304 may be attached to a respective shape memory alloy (SMA) wire. A first SMA wire 310 may be connected between anchor 314 on wedge-shaped structure 302 and an additional anchor structure that is attached to a static structure in optical module 70 (e.g., chassis 80). SMA wire 310 may be configured to control displacement of wedge-shaped structure 302 along the X-direction in FIG. 7A. A second SMA wire 312 may be connected between anchor 316 on wedge-shaped structure 304 and an additional anchor structure that is attached to a static structure in optical module 70 (e.g., chassis 80). SMA wire 312 may be configured to control displacement of wedge-shaped structure 304 along the X-direction in FIG. 7A.

Horizontal displacement of wedge-shaped structure 302 and/or wedge-shaped structure 304 may cause vertical displacement of lens shaping element 88. In the example of FIG. 7A, there is a vertical gap 308-1 between lens shaping element 88 and tapered lens housing portion 80-T. In FIG. 7B, wedge-shaped structure 302 and wedge-shaped structure 304 have been horizontally displaced relative to as in FIG. 7A and there is a vertical gap 308-2 that is greater than vertical gap 308-1 between lens shaping element 88 and tapered lens housing portion 80-T.

As shown in FIG. 7B, SMA wire 310 is shortened to pull wedge-shaped structure 302 in the positive X-direction as indicated by arrow 318. SMA wire 312 is shortened to pull wedge-shaped structure 304 in the negative X-direction as indicated by arrow 320. Tapered structure 306 and lens shaper 88 may not be directly attached to wedge-shape structure 304, allowing wedge-shaped structure 304 to slide relative to tapered structure 306. Similarly, wedge-shaped structure 302 is not directly attached to wedge-shaped structure 304 or tapered structure 80-T, allowing wedge-shaped structure 302 to slide relative to wedge-shaped structure 304 and tapered structure 80-T. Tapered structure 306 may be constrained from moving along the X-direction. Horizontally displacing the wedge-shaped structures as in FIG. 7B therefore causes displacement of tapered structure 306 and lens shaper 88 in the positive Z-direction. The magnitude of vertical gap 308-2 in FIG. 7B is greater than the magnitude of vertical gap 308-1 in FIG. 7A.

Tapered structure 80-T is static and therefore may be referred to as being vertically constrained and horizontally constrained (because the structure does not move in either the horizontal or vertical direction during operation of the actuator). Wedge-shaped structures 302 and 304 are not horizontally constrained and are designed to move along the X-direction. Tapered structure 306 is horizontally constrained but not vertically constrained. FIGS. 7A and 7B show static structures 322 that may be used to horizontally constrain tapered structure 306. Tapered structure 306 therefore moves along the Z-direction in response to horizontal displacement of wedge-shaped structures 302 and 304. Lens shaper 88 is attached to tapered structure 306 and moves in parallel with tapered structure 306. Lens shaper 88 is therefore horizontally constrained but not vertically constrained. Lens shaper 88 moves along the Z-direction in response to horizontal displacement of wedge-shaped structures 302 and 304.

Wedge-shaped structures 302 and 304 may have taper angles and coefficients of friction that are selected to cause the wedge-shaped structures to stay in position when the SMA wire(s) are relaxed. This causes the actuators to require zero holding power, conserving power consumption requirements to operate the actuators.

The example in FIGS. 7A and 7B of actuator 90 including two horizontally displaceable wedge-shaped structures is merely illustrative. If desired, the actuator may include one horizontally displaceable wedge-shaped structure or more than two stacked horizontally displaceable wedge-shaped structures. The example in FIGS. 7A and 7B of lens housing 80 including an integral tapered portion 80-T is merely illustrative. If desired, the lowest wedge-shaped structure 302 may have a lower surface that is parallel to planar upper surface 80-U of chassis 80 (e.g., the wedge-shaped structure 302 may only have one tapered surface). Similarly, structure 306 may optionally have a lower surface that is parallel to planar upper surface 80-U of chassis 80 and the upper wedge-shaped structure 304 may have an upper surface that is parallel to a planar upper surface of chassis 80. Including more tapered surfaces in the actuator may increase the amount of vertical displacement achieved for a given amount of horizontal displacement.

FIGS. 7A and 7B show an example where each wedge-shaped structure is attached to one SMA wire. This example is merely illustrative. Each wedge-shaped structure may optionally be attached to two SMA wires (e.g., one that pulls in the positive X-direction and one that pulls in the negative X-direction).

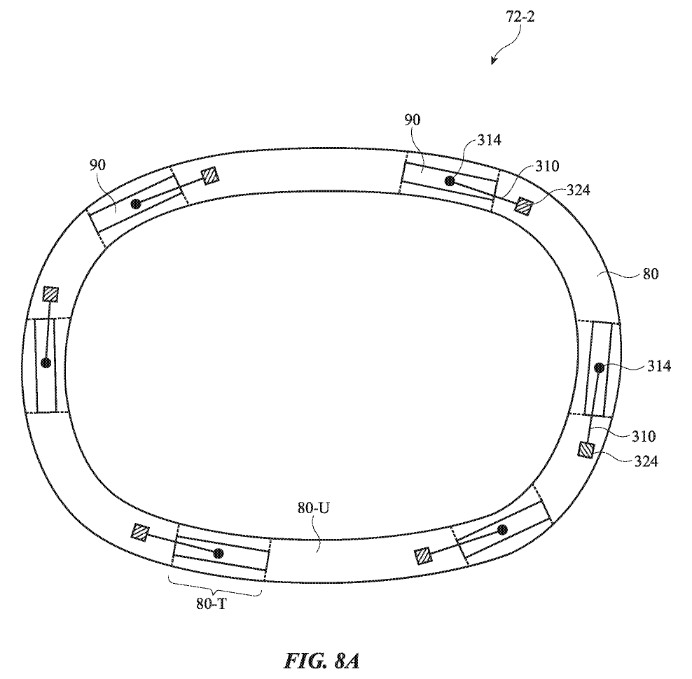

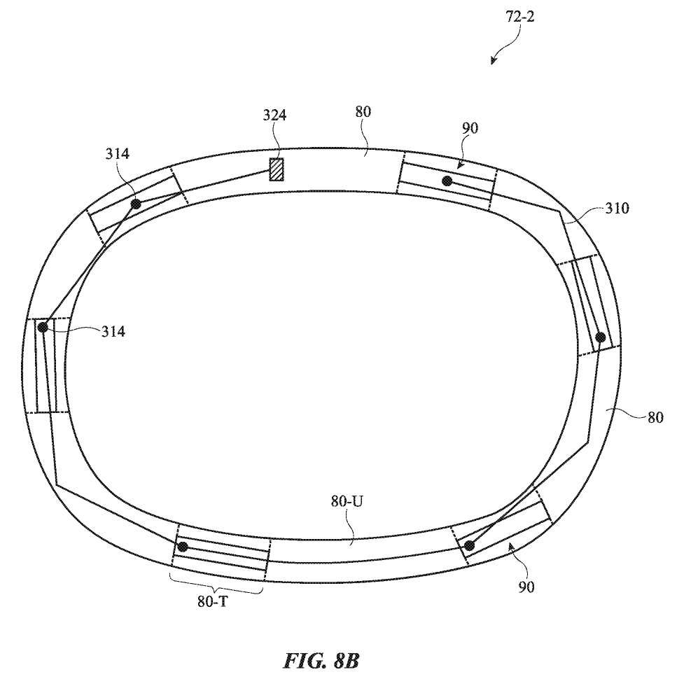

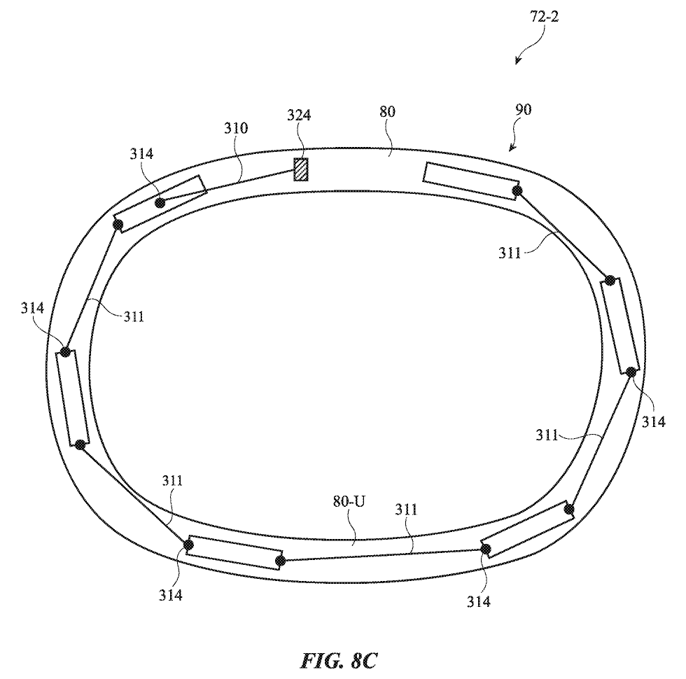

In one possible arrangement each actuator may be individually controlled. FIG. 8A is a top view of an illustrative tunable lens 72-2 with individually controllable actuators 90. As shown, a plurality of actuators is distributed around the perimeter of chassis 80. Each actuator has a respective anchor structure 314 (that is attached to wedge-shaped structure 302 as previously shown) that is attached to a respective SMA wire 310. Each SMA wire 310 is attached between anchor structure 314 and an additional anchor structure 324. Anchor structure 324 may be fixed to chassis 80 or another static structure within optical module 70.

Anchor structures 314 and 324 (sometimes referred to as connector structures 314 and 324, mechanical connection structures 314 and 324, electrical connection structures 314 and 324, mechanical and electrical connection structures 314 and 324, etc.) may be both mechanically and electrically connected to SMA wire 310. Anchor structures 314 and 324 may provide electrical connections to SMA wire 310. Control circuitry 14 may control voltages applied to anchor structures 314 and 324 to control a current through SMA wire 310. The current through SMA wire 310 may be adjusted to selectively contract SMA wire 310. When a current is applied to SMA wire 310 to cause the SMA wire to contract, the contraction may apply a force to anchor structure 314 (and therefore wedge-shaped structure 302).

In FIG. 8A, each actuator has a respective individually controllable SMA wire for each wedge-shaped structure. For simplicity of the drawing, only one SMA wire (for wedge-shaped structure 302) is shown for each actuator 90 in FIG. 8A. However, it should be understood that a second SMA wire (for wedge-shaped structure 304) may also be included for each actuator 90 in FIG. 8A.

To mitigate the number of individually controllable SMA wires in tunable lens 72-2, the actuators may be controlled globally instead of locally. FIG. 8B is a top view of an illustrative tunable lens 72-2 with globally controllable actuators 90. When the actuators are controlled globally, the actuators may sometimes be referred to as actuation points. As shown in FIG. 8B, a single SMA wire 310 is connected to anchor structure 324 on lens housing 80 and an anchor structure 314 on each actuator 90. In other words, each wedge-shaped structure 302 of the actuators of FIG. 8B is connected to a common SMA wire 310. When SMA wire 310 contracts, all of the wedge-shaped structures are horizontally displaced in the clockwise direction. When SMA wire 310 extends, all of the wedge-shaped structures are horizontally displaced in the counter-clockwise direction.

With the arrangement of FIG. 8B, because common SMA wire 310 is connected directly to a plurality of wedge-shaped structures, the wedge-shaped structures may be horizontally displaced by different amounts. Wedge-shaped structures closest to anchor 324 (along the path of SMA wire 310) will be horizontally displaced by less than wedge-shaped structures furthest from anchor 324 (along the path of SMA wire 310).

For global actuator control where the wedge-shaped structures are horizontally displaced by the same amount (by a common wire), the arrangement of FIG. 8C may be used. In the example of FIG. 8C, exactly one actuator of the plurality of actuators around the periphery of the tunable lens has an anchor 314 that is connected to anchor 324 by wire 310 (which may be an SMA wire or a non-SMA wire connected to an additional actuator). The remaining actuators have anchors 314 that are connected to a wedge-shaped structure of a neighboring actuator by a passive mechanical connection 311. The passive mechanical connection 311 may be a wire or rod formed from a non-SMA material such as steel, as one example. Each passive mechanical connection 311 may cause a given wedge-shaped structure to be horizontally displaced in unison with the wedge-shaped structure of a neighboring actuator. Common SMA wire 310 may horizontally displace the wedge-shaped structure to which it is attached by a first amount. The passive mechanical connections propagate the first amount of horizontal displacement to all the other wedge-shaped structures, resulting in uniform horizontal displacement (of the first amount) of the wedge-shaped structures for each actuator in tunable lens 72-2.

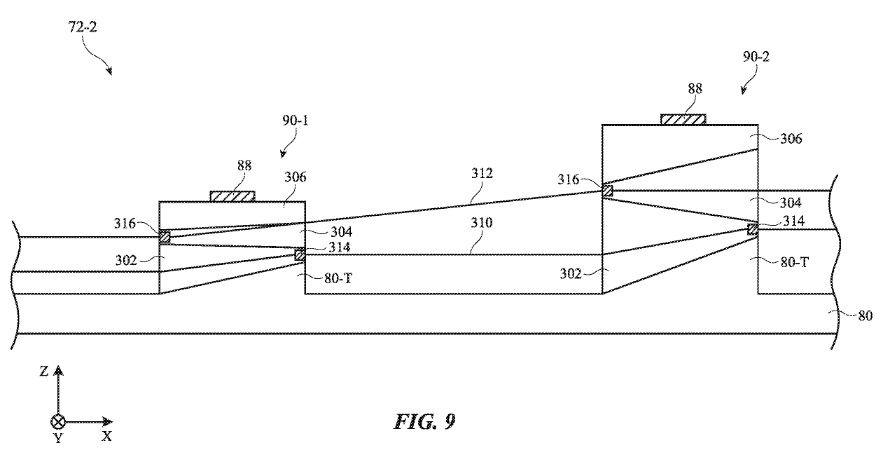

When global actuator control is used as in FIG. 8B or FIG. 8C, the wedge-shaped structures in each actuator may have different shapes to cause different vertical displacement at different actuators with the same horizontal displacements. FIG. 9 is a cross-sectional side view of a tunable lens showing an example of this type. In FIG. 9, first and second actuators 90-1 and 90-2 have the same overall design, with wedge-shaped structures 302 and 304 interposed between horizontally constrained tapered structure 306 and tapered lens housing portion 80-T. However, actuator 90-1 has components with shallower taper angles than actuator 90-2.

In particular, the tapered surface of tapered lens housing portion 80-T may have a greater angle relative to the X-axis in actuator 90-2 than in actuator 90-1. The tapered lower surface of wedge-shaped structure 302 may have a greater angle relative to the X-axis in actuator 90-2 than in actuator 90-1. The tapered upper surface of wedge-shaped structure 302 may have a greater angle relative to the X-axis in actuator 90-2 than in actuator 90-1. The tapered lower surface of wedge-shaped structure 304 may have a greater angle relative to the X-axis in actuator 90-2 than in actuator 90-1. The tapered upper surface of wedge-shaped structure 304 may have a greater angle relative to the X-axis in actuator 90-2 than in actuator 90-1. The tapered lower surface of structure 306 may have a greater angle relative to the X-axis in actuator 90-2 than in actuator 90-1.

In FIG. 9, wedge-shaped structures 302 for both actuators 90-1 and 90-2 are both connected to common SMA wire 310 (similar to as previously shown in FIG. 8B). Horizontal displacement of wedge-shaped structure 302 in the positive X-direction may cause a greater vertical displacement of lens shaper 88 in actuator 90-2 than in actuator 90-1. Horizontal displacement of wedge-shaped structure 304 in the negative X-direction may cause a greater vertical displacement of lens shaper 88 in actuator 90-2 than in actuator 90-1. The shape of the structures in each actuator 90 may therefore be tuned to cause each actuator to have a unique profile of vertical displacement as a function of horizontal displacement.

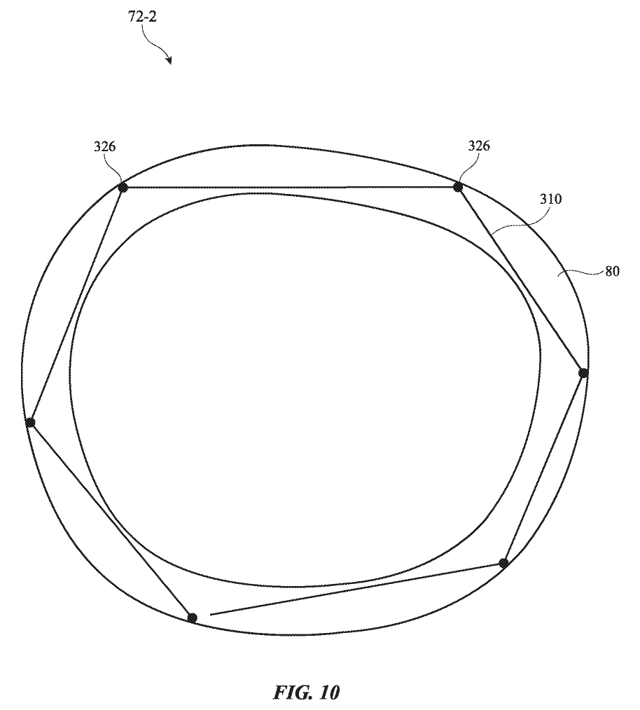

To route an SMA wire within tunable lens 72-2, the tunable lens may include one or more wire redirecting structures. In the example of FIG. 10, SMA wire 310 is routed around a circumference of chassis 80. The SMA wire may have a number of linear subsets that are connected by wire redirecting structures 326. The positions of the wire redirecting structures may be selected to minimize the number of wire redirecting structures while including the SMA wire over the footprint of chassis 80, may be selected to maximize the length of each wire segment, etc.

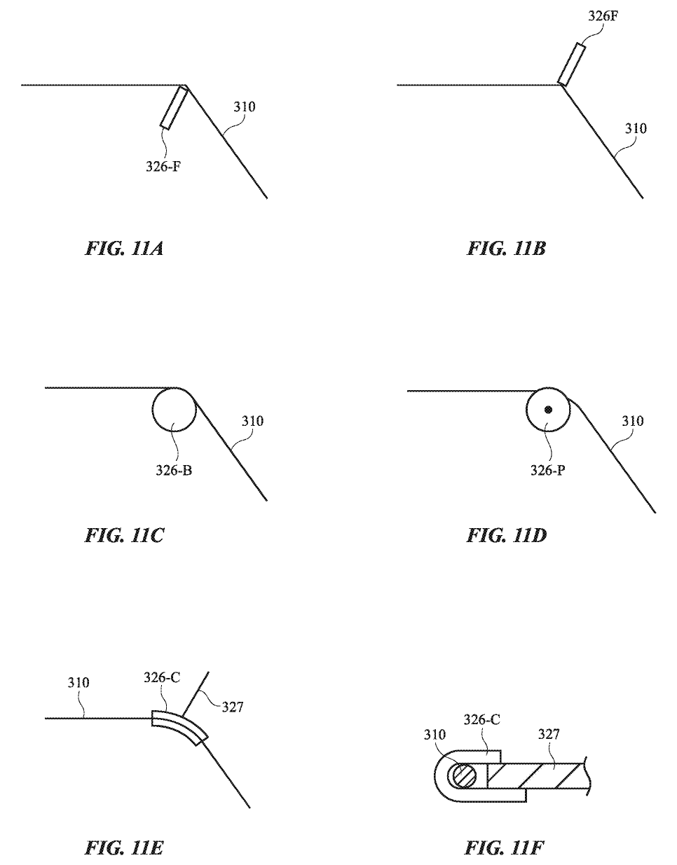

FIG. 11A is a top view of an illustrative wire redirecting structure formed by a flexure 326-F (sometimes referred to as lever 326-F). The flexure 326-F may be formed by a thin structure that is biased against wire 310. The flexure may be formed from plastic, stainless steel, or another desired material. In FIG. 11A, the flexure is positioned on the acute side of the bend in wire 310. In FIG. 11B, the flexure is positioned on the obtuse side of the bend in wire 310.

FIG. 11C is a top view of an illustrative wire redirecting structure formed by a bearing 326-B (sometimes referred to as post 326-B). A bearing is a mechanical component designed to support and guide a rotating or moving part, reducing friction between surfaces while carrying loads. The bearing may be a post with a cylindrical cross-section (as shown in FIG. 11C). The bearing is formed on the acute side of the bend in wire 310.

FIG. 11D is a top view of an illustrative wire redirecting structure formed by a pulley 326-P. The pulley may be a fixed pulley where wire 310 moves relative to a static wheel. The pulley is formed on the acute side of the bend in wire 310.

FIG. 11E is a top view of an illustrative wire redirecting structure formed using a crimp 326-C. As shown in the top view of FIG. 11E, crimp 326-C may overlap and redirect SMA wire 310. The crimp may be attached to a wire 327 that is formed from a non-SMA material. Wire 327 may be formed from steel, as one example. The wire 327 may bias crimp 326-C away from a center of the tunable lens, causing crimp 326-C to create a desired bend in SMA wire 310. FIG. 11F is a side view of the crimp of FIG. 11E. As shown in FIG. 11F, crimp 326-C may wrap around SMA wire 310 such that there is a first portion of the crimp above the SMA wire and a second portion of the crimp below the SMA wire. Crimp 326-C is attached to non-SMA wire 327 that biases the crimp away from the center of the tunable lens.

Crimp 326-C may enclose the SMA wire 310 along a non-zero length of the wire, allowing the crimp to control the route of the wire over a desired distance. In particular, the crimp may constrain SMA wire 310 to a curved path. In this way, the crimp avoids imparting an excessively tight bend on SMA wire 310. It is noted that the example of using a crimp to control the route of the wire over a desired distance is merely illustrative. The wire redirecting structure may instead include a sleeve or other structure that controls the route of a non-zero length of the wire over a desired distance.

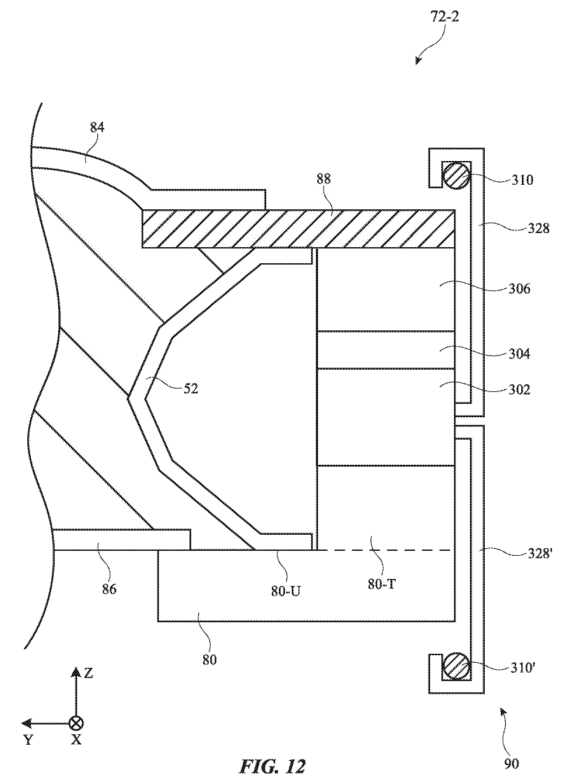

FIG. 12 is a cross-sectional side view of the actuator of FIGS. 7A and 7B integrated into a tunable lens 72-2. As shown in FIG. 12, lens shaping element 88 may have a lower surface attached to both bellows structure 52 and tapered structure 306. Bellows structure 52 is attached between lens shaper 88 and chassis 80. Chassis 80 has an integral tapered portion 80-T. Wedge-shaped structures 302 and 304 are interposed between structure 306 and tapered portion 80-T.

To minimize the width of the actuator in the radial direction (e.g., width 105 from FIG. 6), the SMA wire(s) used to horizontally displace structures 302 and/or 304 may be positioned above lens shaper 88. As shown in FIG. 12, a crimp connection 328 may be attached to both wedge-shaped structure 302 and SMA wire 310. The crimp connection 328 (sometimes referred to as attachment structure 328, crimp 328, etc.) may transfer horizontal displacement imparted by SMA wire 310 to wedge-shaped structure 302. The crimp connection allows for the SMA wire to be routed above lens shaper 88, which may mitigate the number of wire redirecting structures required, mitigate width 105, etc.

As shown in FIG. 12, there may optionally be an additional SMA wire 310’ connected to wedge-shaped structure 302 by an additional crimp connection 328’. The additional SMA wire 310’ may be positioned below chassis 80 by crimp connection 328’. The additional SMA wire 310’ may pull in the same direction as SMA wire 310. The additional SMA wire 310’ may mitigate torque otherwise applied to wedge-shaped structure 302.

The SMA wire arrangement for controlling wedge-shaped structure 302 is shown in FIG. 12. However, it should be understood that the same arrangement may also be used for wedge-shaped structure 304.

Wedge-shaped structure 302, wedge-shaped structure 304, tapered structure 306, and/or tapered lens housing portion 80-T may be referred to as cams. A cam is a machine component used to convert rotational or linear motion into a predefined output motion. The cams described herein convert clockwise or counter-clockwise rotation within the XY-plane into vertical displacement of lens shaper 88.

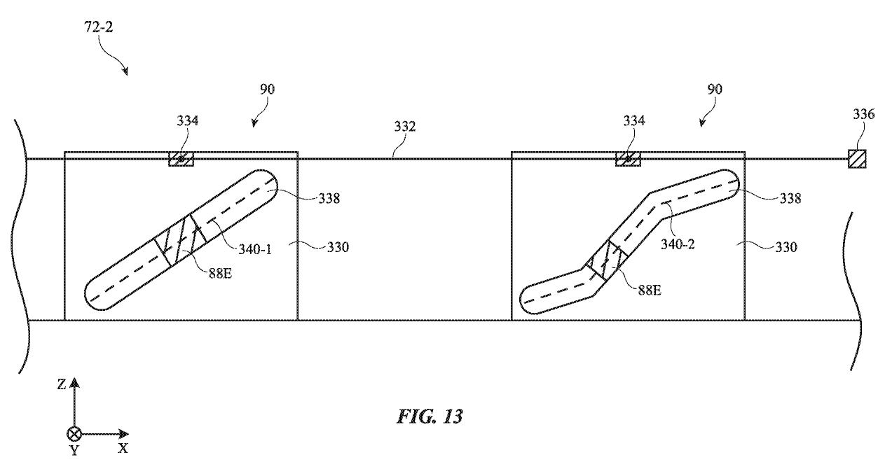

FIG. 13 shows an example where cam structures with slots are connected to a common SMA wire (either directly as in FIG. 8B or via passive connections as in FIG. 8C). As shown, each cam structure 330 overlaps a respective tab 88E of lens shaper 88. Each cam structure 330 has a respective slot 338 that accommodates a respective tab 88E. Each slot is elongated along an axis 340. Cam structure 330 on the left in FIG. 13 has a slot 338 defined by a respective axis 340-1. Cam structure 330 on the right in FIG. 13 has a slot 338 defined by a respective axis 340-2.

Each axis 340 may be at a respective angle (or angles) relative to the XY-plane. In FIG. 13, axis 340-1 has one linear segment at a given angle relative to the XY-plane. Axis 340-2 has three linear segments at respective angles relative to the XY-plane. The angles of the axis segments relative to the XY-plane may be different. A greater angle results in more vertical displacement of the respective tab 88E in that slot during adjustments of the lens. Said another way, each slot that accommodates a respective tab may be oriented at a non-zero, non-orthogonal angle relative to the vertical axis. The slots may be oriented at different angles relative to the vertical axis to allow for different vertical displacement of different tabs based on the same horizontal displacement.

In FIG. 13, the slots 338 are depicted as having a linear geometry. This example is merely illustrative. In another possible arrangement, one or more curved slots may be used to allow more complicated combinations of relative displacement of the tabs 88E.

In FIG. 13, each cam structure 330 has an anchor structure 334 that is attached to global SMA wire 332. SMA wire 332 is connected to anchor structure 336 in addition to anchors 334 on cam structures 330. Anchor structure 336 may be attached to a static component within optical module 70 (e.g., chassis 80). Anchor structures 334 and 336 (sometimes referred to as connector structures 334 and 336, mechanical connection structures 334 and 336, electrical connection structures 334 and 336, mechanical and electrical connection structures 334 and 336, etc.) may be both mechanically and electrically connected to SMA wire 332. Anchor structures 334 and 336 may provide electrical connections to SMA wire 332. Control circuitry 14 may control voltages applied to anchor structures 334 and 336 to control a current through SMA wire 332. The current through SMA wire 332 may be adjusted to selectively contract SMA wire 332. When a current is applied to SMA wire 332 to cause the SMA wire to contract, the contraction may apply a force to anchor structures 334 (and therefore cam structures 330) in the positive X-direction (in FIG. 13).

Cam structures 330 may be referred to as respective actuators 90 and may be distributed around the circumference of the tunable lens as previously shown. In an alternate arrangement, the cam structures of FIG. 13 may include one cam structure that is directly attached to the common SMA wire 332 and the remaining cam structures may be passively connected to the one cam structure (e.g., using passive mechanical connections 311 as discussed in connection with FIG. 8C).

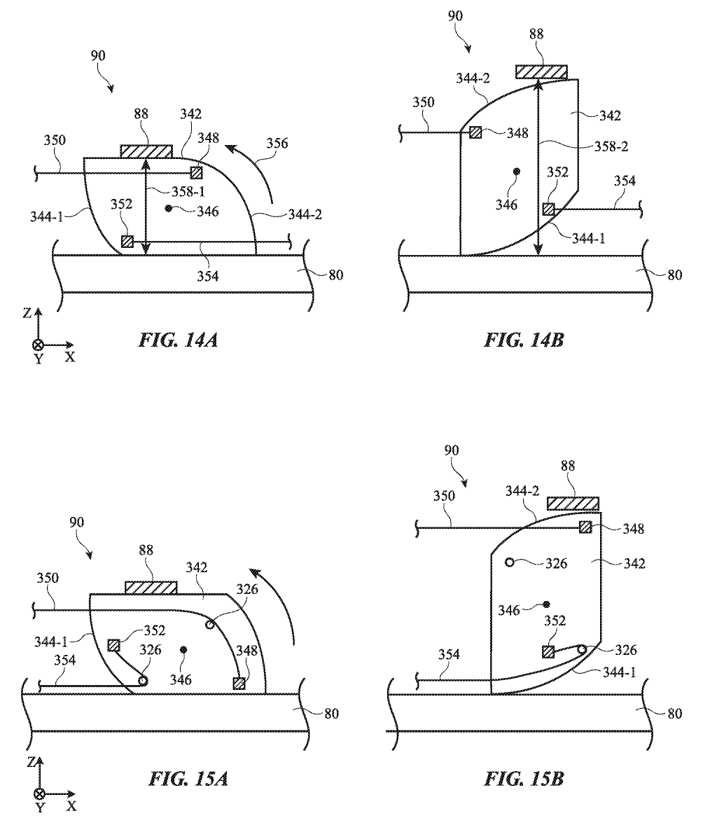

In FIG. 13, a cam structure is included with a slot that translates lateral displacement of the cam structure to vertical displacement of lens shaper 88. In FIGS. 14-15, a cam structure has rounded edges that translate lateral displacement of the cam structure to vertical displacement of lens shaper 88.

FIGS. 14A and 14B are side views of illustrative actuators including cam structures with rounded edges. As shown in FIG. 14A, actuator 90 may include a cam structure 342 with rounded edges 344-1 and 344-2. The rounded edges 344 (sometimes referred to as curved edges, curved sidewalls, rounded sidewalls, etc.) may have any desired curvature. Cam structure 342 (sometimes referred to as a rotary cam) may be configured to rotate around a pivot 346 in a center of the cam structure. Lens shaper 88 may rest on an upper surface of cam structure 342.

Cam structure 342 has a first respective anchor structure 348 that is attached to a respective SMA wire 350. SMA wire 350 is attached between anchor structure 348 and an additional anchor structure. The additional anchor structure may be fixed to chassis 80 or another static structure within optical module 70.

Cam structure 342 has a second respective anchor structure 352 that is attached to a respective SMA wire 354. SMA wire 354 is attached between anchor structure 352 and an additional anchor structure. The additional anchor structure may be fixed to chassis 80 or another static structure within optical module 70.

Anchor structures 348 and 352 (sometimes referred to as connector structures 348 and 352, mechanical connection structures 348 and 352, electrical connection structures 348 and 352, mechanical and electrical connection structures 348 and 352, etc.) may be both mechanically and electrically connected to respective SMA wires. Anchor structures 348 and 352 may provide electrical connections to respective SMA wires. Control circuitry 14 may control voltages applied to anchor structures 348 and 352 (and the additional anchor structures) to control a current through SMA wires 350 and 354. The current through SMA wires 350 and 354 may be adjusted to selectively contract SMA wires 350 and 354. When a current is applied to SMA wires 350 and 354 to cause the SMA wires to contract, the contraction may apply a counter-clockwise force to cam structure 342 as shown by arrow 356 in FIG. 14A.

FIG. 14B shows cam structure 342 from FIG. 14A after a 90 degree counter-clockwise rotation is complete. Lens shaper 88 (or an intermediate structure to which the lens shaper is attached) may rest on the upper surface of structure 342 but may be laterally constrained. The rotation of cam structure 342 therefore causes vertical displacement of lens shaper 88. In FIG. 14B, the gap 358-2 between lens shaper 88 and chassis 80 is greater than gap 358-1 in FIG. 14A.

Actuators having the arrangement of FIGS. 14A and 14B may be distributed around the periphery of the tunable lens. The actuators may be controlled locally (as shown in connection with FIG. 8A) or globally (as shown in connection with FIG. 8B or FIG. 8C). In one example, each actuator has a respective anchor 348 connected to a common SMA wire 350 and each actuator has a respective anchor 352 connected to a common SMA wire 354. This reduces the number of discrete SMA wires needed to control the plurality of actuators. Moreover, different actuators may have different curvature (e.g., different radii of curvature) for edges 344-1 and/or 344-2 to cause varying vertical displacements for the common rotation applied to the actuators by common SMA wires 350 and 354.

In FIGS. 14A and 14B, the SMA wires 350 and 354 contract in opposing directions. To conserve space within the tunable lens, the SMA wires may optionally contract in the same direction. FIGS. 15A and 15B show an example of this type. One or more wire redirecting structures 326 may be included in cam structure 342 to ensure the cam structure rotates in a desired manner. FIG. 15B shows the cam structure of FIG. 15A after a 90 degree counter-clockwise rotation.

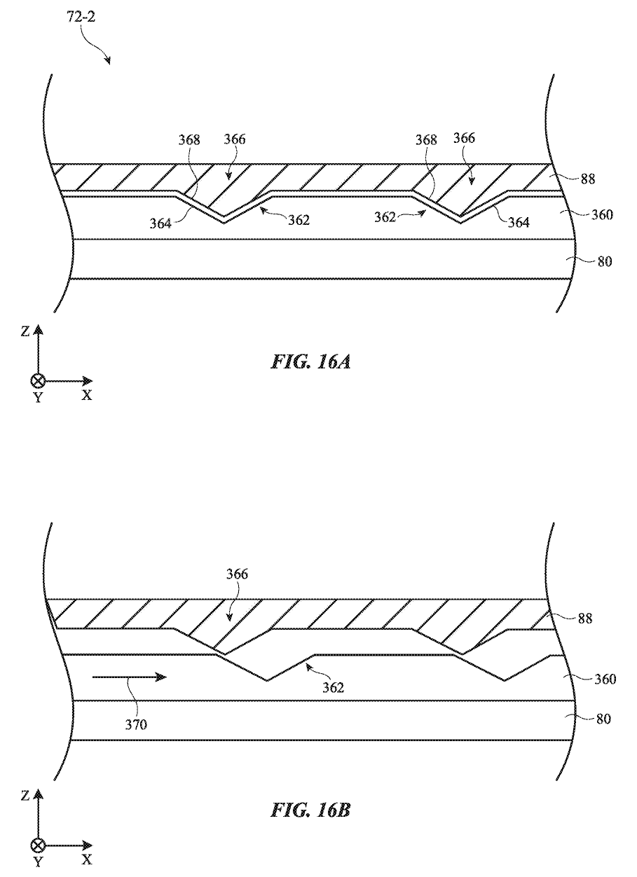

FIGS. 16A and 16B are cross-sectional side views of a tunable lens with a rotating ring that serves as a cam structure. As shown in FIG. 16A, rotating ring 360 may be interposed between chassis 80 and lens shaping element 88. The liquid lens itself or an additional bias force ensures lens shaping element 88 is pushed into contact with 360 at all actuation locations. Rotating ring 360 may have a plurality of recesses 362 that are defined by one or more tapered surfaces 364. Lens shaping element 88 is flexible enough to maintain interface contact between surfaces 364 and 368 for each actuation point around the lens even if their vertical displacements are designed to differ. The interface profiles may be designed to accommodate lens shaping element non-planarity.

Recesses 362 may mate with corresponding protrusions 366 on lens shaping element 88. The protrusions 366 are defined by one or more tapered surfaces 368. The tapered surfaces 368 rest on tapered surfaces 364 and may be parallel to tapered surfaces 364.

Lens shaping element 88 may be constrained from rotating but may not be constrained from moving vertically. FIG. 16B shows an example where ring 360 (sometimes referred to as solid ring 360) has rotated in the positive X-direction, as indicated by arrow 370. Rotating ring 360 in the positive X-direction causes vertical displacement of lens shaping element 88 in the positive Z-direction.

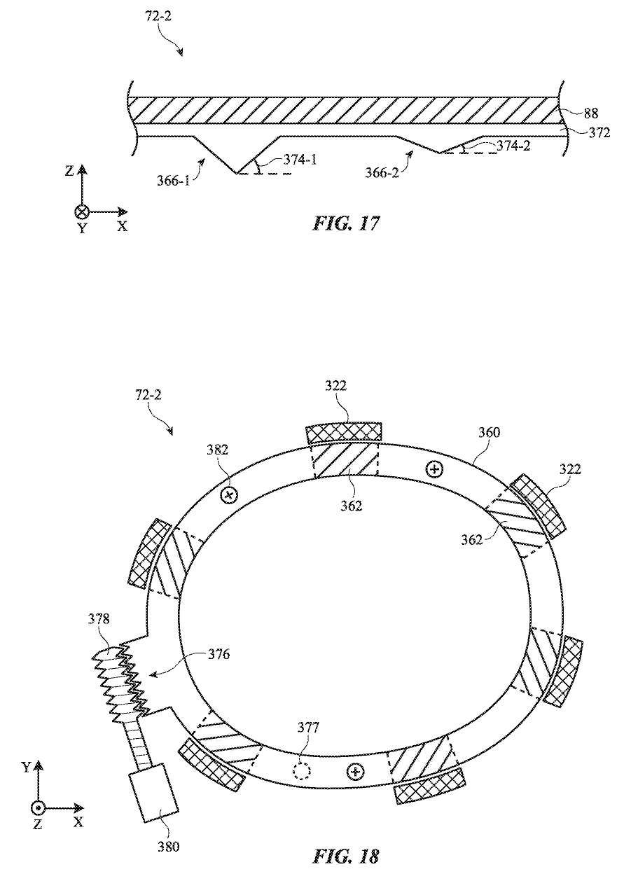

In the example of FIGS. 16A and 16B, the protrusions 366 are formed integrally with lens shaping element 88. In the example where lens shaping element 88 is formed from stainless steel, protrusions 366 are therefore formed from stainless steel integral with the bulk of the lens shaping element. This example is merely illustrative. In another possible arrangement, shown in FIG. 17, lens shaping element 88 may be attached to an additional ring 372 that includes protrusions 366. Ring 372 may have the same footprint as lens shaping element 88. Ring 372 (sometimes referred to as protrusion ring 372, rotating ring 372, etc.) may be attached to lens shaping element 88 with adhesive. Ring 372 includes protrusions 366 similar to as shown in FIGS. 16A and 16B.

FIG. 17 further shows how different protrusions may have different shapes to cause different vertical displacement at different points along the periphery of lens shaping element 88. There may be a plurality of protrusions 366 (and complementary recesses 362) distributed around the circumference of the tunable lens (as previously described in connection with actuators 90). Each protrusion 366 (and complementary recess 362) may have a unique shape to cause a unique vertical displacement for the same amount of rotation of solid ring 360. Protrusion 366-1 has a first shape with a first taper angle 374-1 relative to the XY-plane. Protrusion 366-2 has a second shape with a second taper angle 374-2 relative to the XY-plane. Taper angle 374-1 is greater than taper angle 374-2. Therefore, a given amount of rotation of solid ring 360 will cause a greater vertical displacement of lens shaping element 88 over protrusion 366-1 than over protrusion 366-2.

FIG. 18 is a top view of the tunable lens of FIGS. 16A and 16B showing how there may be one or more static structures 322 that may be used to constrain solid ring structure 360. The static structures 322 may be positioned to allow rotation of solid ring 360 without allowing displacement of the solid ring along the X-direction, Y-direction, or Z-direction.

FIG. 18 further shows how solid ring 360 may include integral teeth 376 that mate with the thread of worm gear 378. Worm gear 378 has a spiral thread that engages with and drives the teeth 376 of solid ring 360. Worm gear 378 may be rotated to selectively rotate solid ring 360 clockwise and counter-clockwise. Rotation of worm gear 378 may be controlled by stepper motor 380 or another desired component. The example of rotating ring 360 using worm gear 378 is merely illustrative. Ring 360 may instead be rotated by an SMA wire, one or more ultrasonic motors, or other desired actuation technique.

FIG. 18 shows ultrasonic motor 377 that may optionally be included instead of worm gear 378 and stepper motor 380. Ultrasonic motor 377 may be positioned between ring 360 and chassis 80.

One or more set screws 382 may be attached to chassis 80, solid ring 360, and/or lens shaping element 88. In the example of FIG. 18, there are three set screws 382 distributed evenly around the circumference of the tunable lens. The set screws may be selectively tightened (e.g., during manufacturing or calibration of the tunable lens) to adjust the tilt of lens shaping element 88 relative to chassis 80. Adjusting the tilt of lens shaping element 88 may desirably allow for adjustments to the lens optical center of tunable lens 72-2.

In FIGS. 16 and 17, the tapered surfaces 364/368 are depicted as having a linear geometry. This example is merely illustrative. In another possible arrangement, one or more protrusions/recesses may have complementary curved surfaces to allow more complicated combinations of relative displacement of the lens shaper.

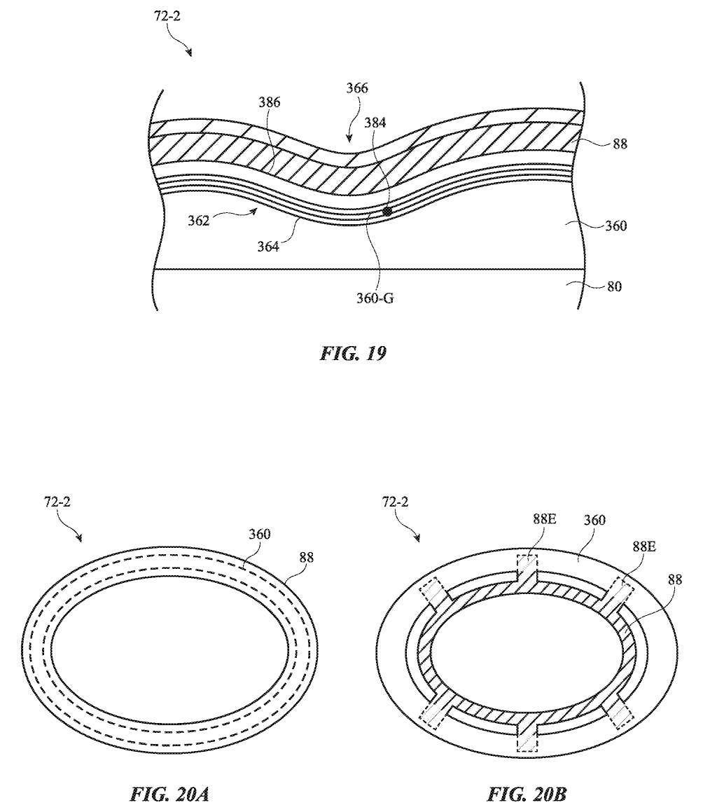

FIG. 19 is a cross-sectional side view of an illustrative tunable lens with a rotating ring 360 and lens shaping element 88 having curved recesses and protrusions, respectively. As shown, rotating ring 360 has a recess 362 defined by a surface 364 with curvature. Lens shaping element 88 has a protrusion 366 defined by a surface 368 with curvature. The curvature of surfaces 364 and 368 may be complementary such that protrusion 366 mates with recess 362 in the absence of a horizontal displacement on rotating ring 360.

FIG. 19 additionally shows how an upper surface of rotating ring 360 may include a groove 360-G with a ball bearing 384 to mitigate friction between ring 360 and lens shaping element 88 during rotation of ring 360.

In one possible arrangement, shown in FIG. 20A, ring 360 may have a footprint that is aligned with lens shaping element 88. The solid ring may be positioned directly below the lens shaping element (e.g., between the lens shaping element and the chassis as shown in FIGS. 16A and 16B) or directly above the lens shaping element (such that the lens shaping element is interposed between the ring and the chassis). With this arrangement, tabs 88E may be omitted from lens shaping element 88. Having ring 360 directly overlap the lens shaping element may desirably mitigate the space requirements for a bezel for the tunable lens (e.g., by mitigating widths 103/105 from FIG. 6).

In an alternate arrangement, shown in FIG. 20B, lens shaping element 88 includes tabs 88E that directly overlap solid ring 360. In general, for any of the actuator arrangements described herein, the actuators may be positioned directly above or below the lens shaping element 88 (and tabs 88E are omitted) or may be positioned directly above or below lens shaping element tabs 88E.

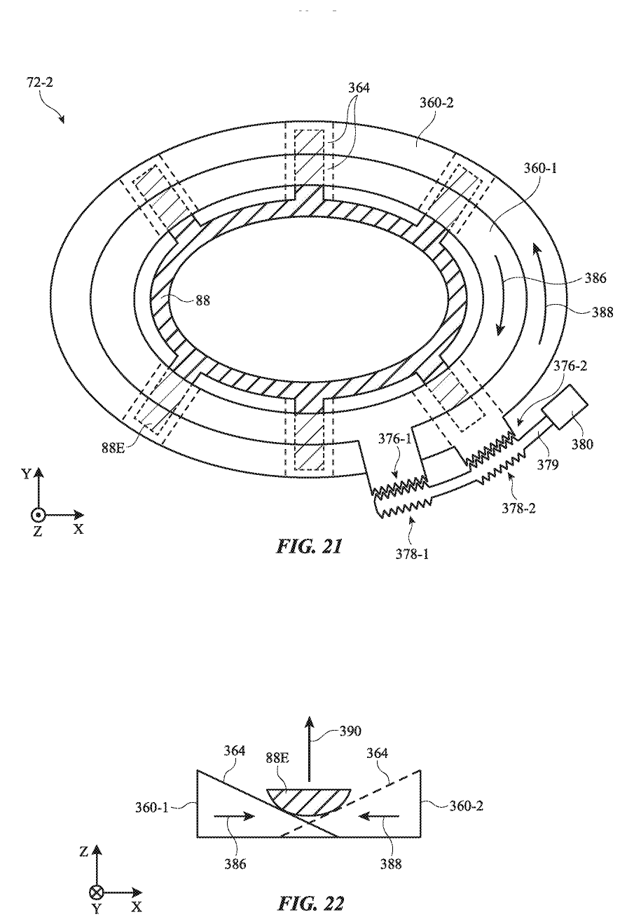

Tunable lens 72-2 may optionally include two rotating rings that are configured to rotate in opposite directions. FIG. 21 is a top view of an illustrative tunable lens of this type. As shown in FIG. 21, the tunable lens includes a first rotating ring 360-1 and a second rotating ring 360-2. The first rotating ring 360-1 may be laterally surrounded by the second rotating ring 360-2. Rotating ring 360-1 may be referred to as the inner rotating ring whereas rotating ring 360-2 may be referred to as the outer rotating ring. Rings 360-1 and 360-2 may be concentric.

In the arrangement of FIG. 21, each one of rotating rings 360-1 and 360-2 may have respective tapered surfaces 364 that are aligned with respective lens shaping element tabs 88E. The tapered surfaces 364 may be angled in opposite directions such that the tab rests on the tapered surfaces of both rings simultaneously. FIG. 22 is a cross-sectional side view of the tunable lens of FIG. 21 showing how tab 88E rests on the tapered surfaces of rings 360-1 and 360-2. If desired, tab 88E may have a curved lower surface as in FIG. 22 to better match the tapered surfaces of rings 360-1 and 360-2. Ring 360-1 may rotate clockwise as indicated by arrow 386 in FIGS. 21 and 22. Ring 360-2 may rotate counter-clockwise as indicated by arrow 388 in FIGS. 21 and 22. The simultaneously opposing rotation of rings 360-1 and 360-2 causes vertical displacement of tab 88E, as indicated by arrow 390 in FIG. 22. The counter rotating ring in FIGS. 21 and 22 mitigates the torque on the lens shaper 88 and is an alternative to constraining lens shaper 88 rotation. The magnitude of angular rotation of each ring in FIGS. 21 and 22 may be equal and opposite (e.g., by having them geared together).

In FIGS. 21 and 22, tapered surfaces 364 in rings 360-1 and 360-2 may be defined by protrusions or recesses in the solid rings. The tapered surfaces associated with different tabs 88E may have different slopes and/or geometries to cause different vertical displacement profiles for the different tabs as a function of the same rotation of rings 360-1 and 360-2.

Rotating rings 360-1 and 360-2 in FIG. 21 may be driven by any desired actuators. In one example, shown in FIG. 21, the rotating rings 360-1 and 360-2 may each include integral teeth 376 that mate with the thread of a respective worm gear 378. Ring 360-1 has integral teeth 376-1 that mate with a respective worm gear 378-1. Worm gear 378-1 has a spiral thread that engages with and drives the teeth 376-1 of solid ring 360-1. Ring 360-2 has integral teeth 376-2 that mate with a respective worm gear 378-2. Worm gear 378-2 has a spiral thread that engages with and drives the teeth 376-2 of solid ring 360-2. Worm gears 378-1 and 378-2 may optionally have respective shafts and stepper motors if desired. Alternatively, as shown in FIG. 21, worm gears 378-1 and 378-2 may share a common shaft 379 and stepper motor 380. The worm gears 378-1 and 378-2 may have opposite thread types such that rotation of shaft 379 in a given direction causes rings 360-1 and 360-2 to rotate in opposite directions. Shaft 379 may be rotated a first direction to selectively rotate solid ring 360-1 clockwise and solid ring 360-2 counter-clockwise. Shaft 379 may be rotated a second, opposing direction to selectively rotate solid ring 360-1 counter-clockwise and solid ring 360-2 clockwise. Rotation of shaft 379 may be controlled by stepper motor 380 or another desired component.

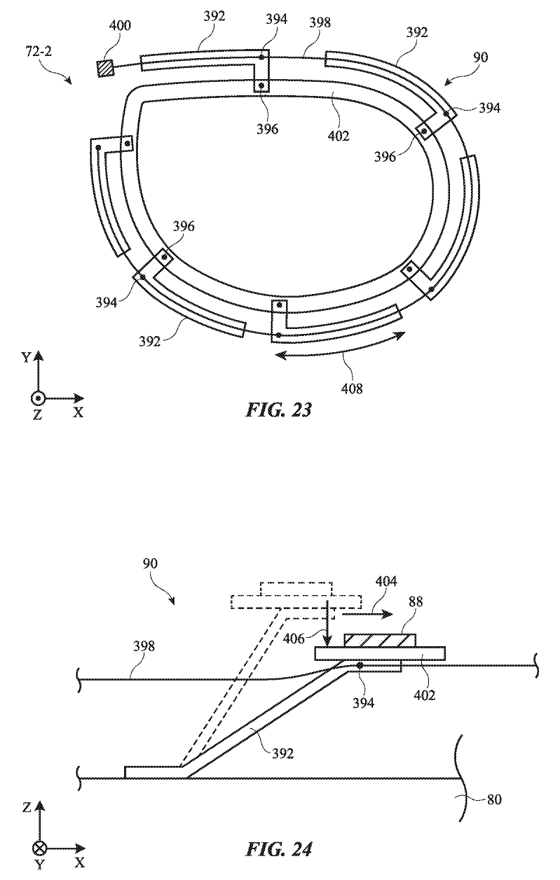

FIG. 23 is a top view of an illustrative tunable lens with flexures that are used to selectively adjust lens shaping element 88 based on global control by a common wire. FIG. 24 is a cross-sectional side view of an illustrative actuator with a flexure from FIG. 23.

As shown in FIGS. 23 and 24, each actuator 90 may include a flexure 392 that is attached between chassis 80 and a common ring 402. Common ring 402 may extend around the circumference of tunable lens 72-2. Common ring 402 may be attached to lens shaping element 88 at one or more locations. Common ring 402 may optionally be omitted and the flexures may be attached directly to the lens shaping element if desired.

Each flexure may be formed from plastic, stainless steel, or another desired material. The bottom of flexure 392 may be attached to a static component such as chassis 80. The flexures may have shape that causes vertical displacement of the top of the flexure to vary as a function of horizontal displacement of the top of the flexure. FIG. 24 shows how the top of flexure 392 may be rotated in the positive X-direction, causing horizontal displacement 404 of the top of flexure 392 in the positive X-direction. The horizontal displacement 404 may cause a corresponding vertical displacement 406 in the top of the flexure. Flexures 392 may sometimes be referred to as helical flexures. The vertical displacement of common ring 402 (and, correspondingly, lens shaping element 88), may therefore be controlled by selective rotation of flexures 392.

As shown in FIG. 23, a single SMA wire 398 may be connected to anchor structure 400 on a static component within the optical module (e.g., chassis 80) and an anchor structures 394 on each flexure 392. In other words, each flexure may be connected to a common SMA wire 398 (similar to as discussed in connection with FIG. 8B). When SMA wire 398 contracts, the tops of all of the flexures are horizontally displaced in the counter-clockwise direction. When SMA wire 398 extends, all of the wedge-shaped structures are horizontally displaced in the clockwise direction.

In an alternate arrangement, the flexures of FIG. 23 may include one flexure that is directly attached to the common SMA wire 398 and the remaining flexures may be passively connected to the one flexure (e.g., using passive mechanical connections 311 as discussed in connection with FIG. 8C). In yet another possible arrangement, wire 398 may be a non-SMA wire that is pulled using a motor that winds the wire around a shaft.

When global actuator control is used, the flexures in each actuator may have different shapes to cause different vertical displacement at different actuators with the same horizontal displacements. As an example, each flexure may have a lever arm with a corresponding length 408. The length 408 of different flexures may be different to cause different vertical displacement profiles for different actuators.

FIGS. 23 and 24 show an example where the SMA wire is attached to flexures 392 directly. In another possible arrangement, common ring 402 may be rotated by a SMA wire or other actuation mechanism instead of rotating the flexures directly. In yet another possible arrangement, common ring 402 may be omitted and the flexures may be attached directly to the lens shaping element. The lens shaping element may then be rotated by a SMA wire or other actuation mechanism instead of rotating the flexures directly.

The example in FIG. 24 of lens shaping element 88 being moved in the X-direction in FIG. 24 is merely illustrative. Instead or in addition, the lens shaping element may slide along common ring 402 (e.g., along the Y-direction).

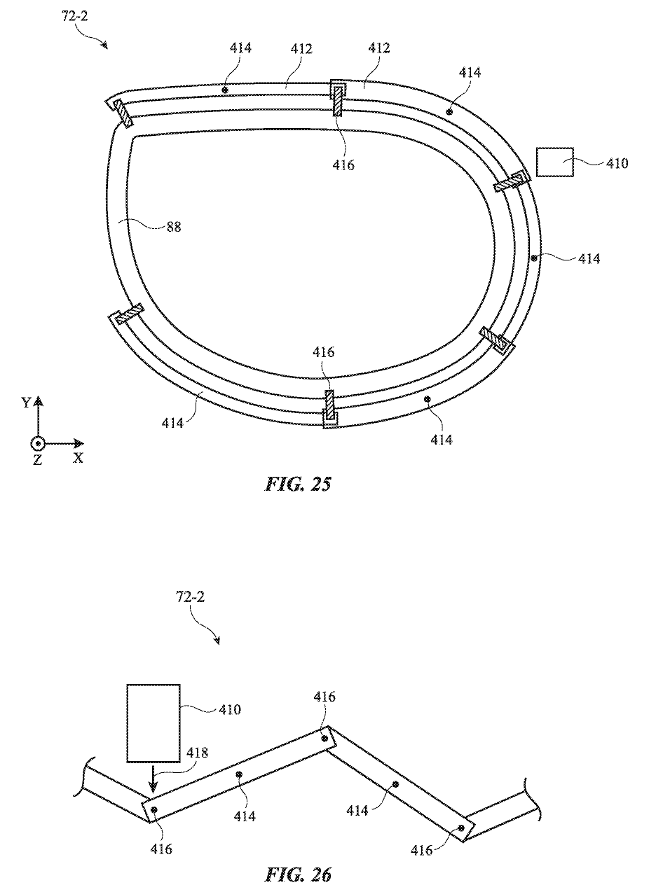

FIG. 25 is a top view of an illustrative tunable lens with linkages and pivots that are used to selectively adjust lens shaping element 88 based on global control by a common actuator. FIG. 26 is a cross-sectional side view of the illustrative tunable lens of FIG. 25.

As shown in FIG. 25, a plurality of linkages 412 (sometimes referred to as links 412) may be distributed round the circumference of tunable lens 72-2. The linkages are rigid bars connected by pivots (also called joints). The linkages are designed to transfer vertical displacement of one joint 416 by common actuator 410 to vertical displacements of lens shaping element at various points around the periphery of the lens shaping element.

As shown in FIG. 25, each adjacent pair of links 412 may be connected by a pivot 416 (sometimes referred to as joint 416). There are also one or more pivots 414 that are connected to a static component within the tunable lens such as chassis 80. The vertical displacement of the links at pivots 414 is therefore fixed. The vertical displacement of the links at joints 416 varies based on actuator 410 selectively adjusting the vertical displacement of one joint 416. Lens shaping element 88 may have tabs that are connected to joints 416 or joints 416 may include a component that is attached to the lens shaping element 88.

With the arrangement of FIG. 26, a single actuator 410 may adjust the vertical displacement of one joint 416 (e.g., by applying a force to the joint in direction 418 as in FIG. 26). The vertical displacement of the one joint causes corresponding vertical displacements in additional joints 416. The size of links 412 and the positions of pivots 414 may be selected to cause desired vertical displacement profiles at each attachment point to lens shaping element 88.

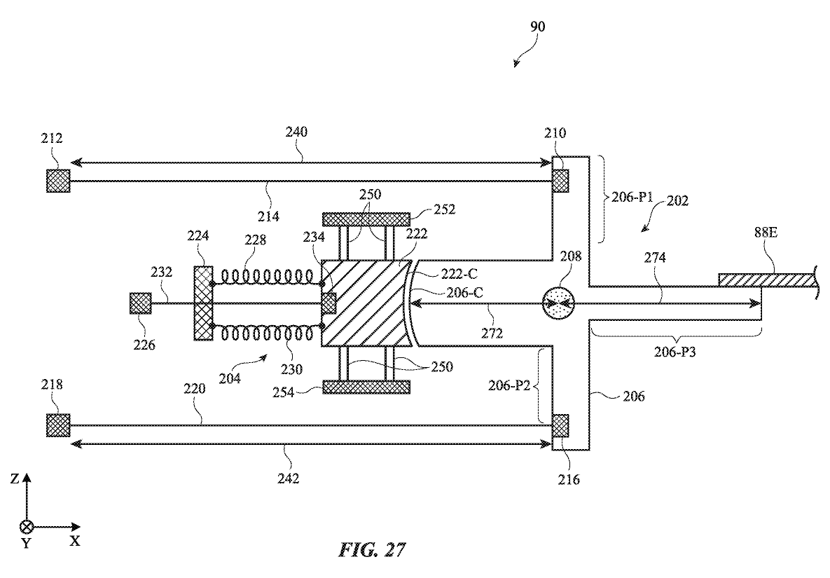

FIG. 27 is a cross-sectional side view of an illustrative SMA actuator 90 that may be used in tunable lens 72-2. As shown in FIG. 27, the actuator may include a pivot assembly 202 and a brake assembly 204.

Pivot assembly 202 includes a structure 206 (sometimes referred to as rotating structure 206, moveable structure 206, main structure 206, etc.) that is configured to rotate around pivot structure 208. Pivot structure 208 may include a pin or other desired structure. Structure 206 may have an opening that is aligned with and receives pivot structure 208. As shown in FIG. 27, rotating structure 206 may include a first protruding portion 206-P1, a second protruding portion 206-P2, and a third protruding portion 206-P3. The item intended to be moved by actuator 90 may be attached to third protruding portion 206-P3. In this example, the item intended to be moved by actuator 90 is extension 88E but other components may be moved by actuator 90 if desired.

FIG. 27 shows how a portion of lens shaping element 88 such as extension 88E may be attached to third protruding portion 206-P3. Rotation of structure 206 around pivot structure 208 therefore causes displacement of extension 88E along the Z-direction. One or more intervening components may be included between extension 88E and protruding portion 206-P3 to constrain displacement of extension 88E to only the Z-direction.

A first SMA wire 214 may be connected between anchor structures 210 and 212. Anchor structures 210 and 212 (sometimes referred to as connector structures 210 and 212, mechanical connection structures 210 and 212, electrical connection structures 210 and 212, mechanical and electrical connection structures 210 and 212, etc.) may be both mechanically and electrically connected to SMA wire 214. Mechanically, anchor structure 212 may be attached to a fixed structure in tunable lens 72-2 such as lens housing 80 or a housing for the actuator whereas anchor structure 210 may be attached to portion 206-P1 of structure 206. Anchor structures 210 and 212 may also provide electrical connections to SMA wire 214. Control circuitry 14 may control voltages applied to anchor structures 210 and 212 to control a current through SMA wire 214. The current through SMA wire 214 may be adjusted to selectively contract SMA wire 214. When a current is applied to SMA wire 214 to cause the SMA wire to contract, the contraction may apply a force to anchor structure 210 (and therefore portion 206-P1 of structure 206) in the negative X-direction.

The aforementioned example of the anchor structures being attached to other components (e.g., lens housing 80, portion 206-P1, etc.) is merely illustrative. The anchor structures may be discrete structures that are attached to other device components. Alternatively, the anchor structures may be portions of the other device components. For example, a portion of lens housing 80 and/or structure 206 may serve as mechanical anchor structures for SMA wire 214 (without an intervening discrete anchor structure). This is true for all of the anchor structures described herein.

A second SMA wire 220 may be connected between anchor structures 216 and 218. Anchor structures 216 and 218 (sometimes referred to as connector structures 216 and 218, mechanical connection structures 216 and 218, electrical connection structures 216 and 218, mechanical and electrical connection structures 216 and 218, etc.) may be both mechanically and electrically connected to SMA wire 220. Mechanically, anchor structure 218 may be attached to a fixed structure in tunable lens 72-2 such as lens housing 80 or a housing for the actuator whereas anchor structure 216 may be attached to portion 206-P2 of structure 206. Anchor structures 216 and 218 may also provide electrical connections to SMA wire 220. Control circuitry 14 may control voltages applied to anchor structures 216 and 218 to control a current through SMA wire 220. The current through SMA wire 220 may be adjusted to selectively contract SMA wire 220. When a current is applied to SMA wire 220 to cause the SMA wire to contract, the contraction may apply a force to anchor structure 216 (and therefore portion 206-P2 of structure 206) in the negative X-direction. Control circuitry 14 may therefore control the contraction of SMA wires 214 and 220, which selectively rotates structure 206 around pivot structure 208, which selectively moves extension 88E along the Z-direction.

Actuator 90 may include brake assembly 204 in addition to pivot assembly 202. Brake assembly 204 may be configured to selectively apply a bias force to rotating structure 206 to hold the rotating structure 206 in a fixed position. The brake may fix the position of rotating structure 206 when actuator 90 is not receiving power. Including the brake may therefore reduce the power consumption required to operate actuator 90.

As shown in FIG. 27, brake assembly 204 may include a brake structure 222. One or more bias structures such as springs may be coupled between brake structure 222 and anchor 224. In FIG. 27, springs 228 and 230 are coupled between brake structure 222 and anchor 224. Anchor structure 224 may be attached to a fixed structure in tunable lens 72-2 such as lens housing 80 or a housing for the actuator. Springs 228 and 230 may bias brake structure 222 in the positive X-direction towards structure 206. In the absence of a force from SMA wire 232, brake structure 222 presses into structure 206 to fix the position of structure 206. As shown in FIG. 27, brake structure 222 may have a concave surface 222-C that mates with a corresponding convex surface 206-C of structure 206 or vice versa (e.g., brake structure 222 may have a convex surface 222-C that mates with a corresponding concave surface 206-C of structure 206).

A third SMA wire 232 may be connected between anchor structures 226 and 234. Anchor structures 226 and 234 (sometimes referred to as connector structures 226 and 234, mechanical connection structures 226 and 234, electrical connection structures 226 and 234, mechanical and electrical connection structures 226 and 234, etc.) may be both mechanically and electrically connected to SMA wire 232. Mechanically, anchor structure 226 may be attached to a fixed structure in tunable lens 72-2 such as lens housing 80 or a housing for the actuator whereas anchor structure 234 may be attached to brake structure 222. Anchor structures 226 and 234 may also provide electrical connections to SMA wire 232. Control circuitry 14 may control voltages applied to anchor structures 226 and 234 to control a current through SMA wire 232. The current through SMA wire 232 may be adjusted to selectively contract SMA wire 232. When a current is applied to SMA wire 232 to cause the SMA wire to contract, the contraction may apply a force to anchor structure 234 (and therefore brake structure 222) in the negative X-direction.

When SMA wire 232 pulls brake structure 222 with sufficient force to overcome the bias force provided by bias structures 228/230, brake structure 222 moves in the negative X-direction. This may be referred to as releasing the brake. While the brake is released, structure 206 may rotate freely around pivot structure 208. It is noted that the brake does not need to be fully disengaged to enable movement of structure 206. The frictional force between the brake structure 222 and structure 206 just needs to be less than the drive force to allow movement of structure 206. SMA wires 214/220 may be used to rotate structure 206 while the brake is released. Once structure 206 is in a desired position, the brake may be engaged by relaxing SMA wire 232 such that brake structure 222 is again biased into structure 206. The position of structure 206 is thereafter fixed while the brake is engaged.

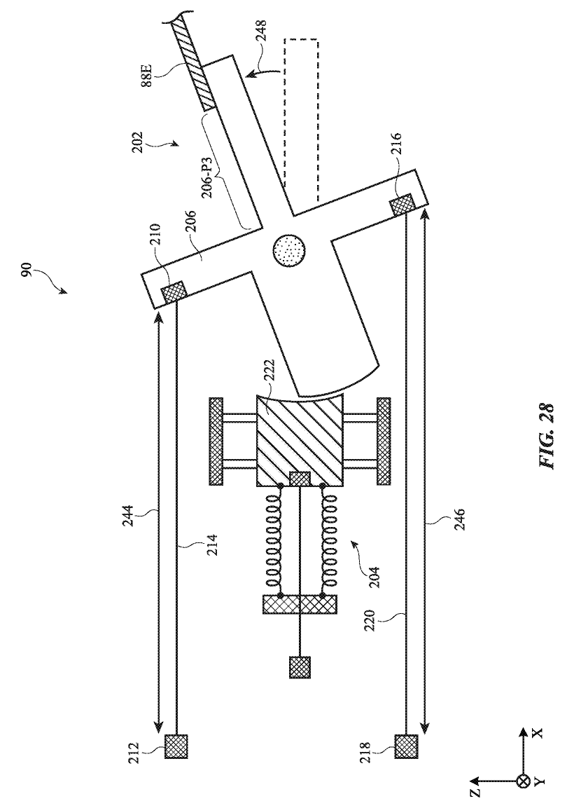

FIGS. 27 and 28 show an example of structure 206 being rotated to move extension 88E in the positive Z-direction. In FIG. 27, SMA wire 214 has a first length 240 and SMA wire 220 has a second length 242. In FIG. 28, SMA wire 214 has been contracted and the length of SMA wire 214 has been reduced to a third length 244 that is less than first length 240 from FIG. 27. Meanwhile SMA wire 220 has been relaxed and the length of SMA wire 220 in FIG. 28 has been increased to a fourth length 246 that is greater than second length 242 from FIG. 27. As shown in FIG. 28, this change in the forces applied by SMA wires 214 and 220 causes structure 206 (including protruding portion 206-P3 and therefore extension 88E) to rotate in counterclockwise direction 248. Rotating structure 206 counterclockwise in this manner moves extension 88E in the positive Z-direction. In the opposite arrangement (e.g., when length 244 increases and length 246 decreases), structure 206 may rotate clockwise which moves extension 88E in the negative Z-direction.

As shown in FIG. 27, structure 206 may have a length 272 between the center of pivot structure 208 and convex surface 206-C and a length 274 between the center of pivot structure 208 and the end of protruding portion 206-P3. The friction force at the interface of surfaces 222-C and 206-C may be proportional to the ratio of the gearing between extension 88E and frictional translation. To lower the normal force required on the friction surface, the ratio of the length 272 to length 274 may be increased. Lowering the normal force using a relatively high ratio of length 272 to length 274 may allow for a smaller and more compact bias structure(s) 228/230, lower stresses within the system, and a lower required force for SMA wire 232 that releases the braking structure. The ratio of length 272 to length 274 may be at least 0.25, at least 0.3, at least 0.4, at least 0.5, at least 0.75, at least 1, at least 1.5, at least 2, at least 3, etc.

To improve the performance of actuator 90, it may be desirable to include one or more components that limit undesired shifting of brake structure 222 along the Z-direction. If brake structure 222 shifts along the Z-direction, there may be backlash that prevents extension 88E from being moved in a desired manner.

To mitigate motion of brake structure 222 in the Z-direction, brake structure 222 may be attached to one or more guide structures 250. First and second guide structures 250 may be attached between anchor structure 252 and brake structure 222 on the positive Z-side of brake structure 222. Third and fourth guide structures 250 may be attached between anchor structure 254 and brake structure 222 on the negative Z-side of brake structure 222.

Anchor structures 252 and 254 may be attached to a fixed structure in optical module 70 such as chassis 80 or a housing for the actuator. Each one of guide structures 250 may have a high stiffness in the Z-direction and the Y-direction but a low stiffness in the X-direction. The guide structures may therefore limit undesired motion of brake structure 222 along the Z-axis while allowing the desired motion of brake structure 222 along the X-axis. Guide structures 250 in FIG. 27 may be referred to as flexures. The flexures may be formed from any desired material (e.g., plastic, a metal such as aluminum, etc.). The flexures may have a first dimension in the Z-direction, a second dimension in the Y-direction, and a third dimension in the X-direction. The third dimension may be smaller than the first and/or second dimensions. The first dimension may be at least 2x greater than the third dimension, at least 4x greater than the third dimension, at least 8x greater than the third dimension, at least 16x greater than the third dimension, etc. The second dimension may be at least 2x greater than the third dimension, at least 4x greater than the third dimension, at least 8x greater than the third dimension, at least 16x greater than the third dimension, etc.

SMA wire 220 and anchors 216 and 218 may optionally be omitted from actuator 90 in FIGS. 27 and 28. With this arrangement, the vertical displacement of tab 88E is controlled only by SMA wire 214 (and the brake assembly 204).

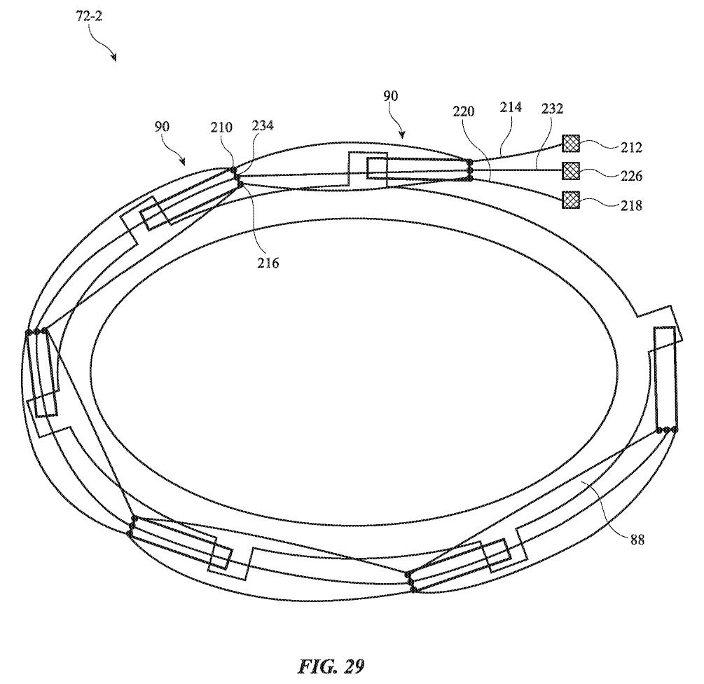

FIG. 29 is a top view of a tunable lens including the SMA actuators of FIGS. 27 and 28 with a global control scheme similar to the global control scheme of FIG. 8B. As shown in FIG. 29, the SMA actuators may be distributed around the circumference of lens shaping element 88. Each SMA actuator may be coupled to a respective tab 88E. Each SMA actuator has a respective anchor 210, 216, and 234. Anchor 210 for each actuator is connected to a common wire 212 (which may be a SMA wire or a non-SMA wire). Anchor 216 for each actuator is connected to a common wire 220 (which may be a SMA wire or a non-SMA wire). Anchor 234 for each actuator is connected to a common wire 226 (which may be a SMA wire or a non-SMA wire). With this arrangement, three wires 214, 232, and 220 may control the rotation and braking of the plurality of actuators around tunable lens 72-2. Passive mechanical connections 311 may optionally be included between anchors in adjacent actuators. Each common wire may be pulled an actuator (e.g., an SMA wire or another desired type of actuator).

When global control of SMA actuators is used, the SMA actuators may have different geometries to enable different vertical displacement profiles at different actuators. In particular, the lengths of protruding portions 206-P1 and 206-P2 and/or length 274 may be different between different actuators to cause different vertical displacements at different actuators. As a specific example, a first SMA actuator may have a first length 274 and a second SMA actuator may have a second length 274 that is greater than the first length. The second SMA actuator may cause more vertical displacement of tab 88E when rotated by the same amount as the first actuator (per the global control by SMA wires 214, 220, and 232).

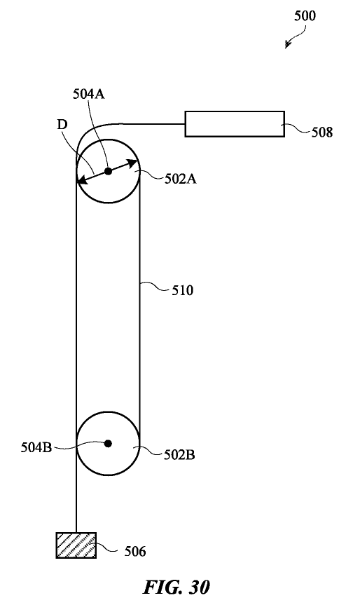

Regardless of the brakes and/or SMA wire routing used in tunable lens 72-2, the SMA wire(s) in tunable lens 72-2 may be wrapped around pulleys in electronic device 10. An illustrative example is shown in FIG. 30.

As shown in FIG. 30, pulley system 500 may include pulleys 502A and 502B. Pulleys 502A and 502B may be fixed pulleys that are fixed at respective axles 504A and 504B. Axles 504A and 504B may be oriented parallel to the optical axis of the tunable lens (e.g., tunable lens 72-2), may be oriented perpendicular to the optical axis of the tunable lens, or may be oriented in another suitable orientation. Pulleys 502A and 502B may each have diameter D, which may be at least 1 mm, at least 2 mm, between 0.5 mm and 5 mm, or another suitable diameter.

SMA wire 510, which may be any suitable SMA wire previously described (e.g., SMA wire 310 of FIG. 8B, SMA wire 312 of FIG. 7A, SMA wire 310’ of FIG. 12, SMA wire 332 of FIG. 13, SMA wire 350 or 354 of FIG. 14, SMA wire 398 of FIG. 23, or SMA wire 214, 220, or 232 of FIG. 27), may be wrapped around pulleys 502A and 502B. For example, SMA wire 510 may be wrapped around pulleys 502A and 502B at least once, at least twice, at least three times, at least five times, at least ten times, or any other suitable number of times.

SMA wire 510 may be fixed at end 506 and may have moving end 508. Moving end 508 may be coupled to any suitable tabs, extensions, and/or joints of tunable lens 72-2. Alternatively or additionally, movable end 508 may be coupled to a portion of a brake within tunable lens 72-2.

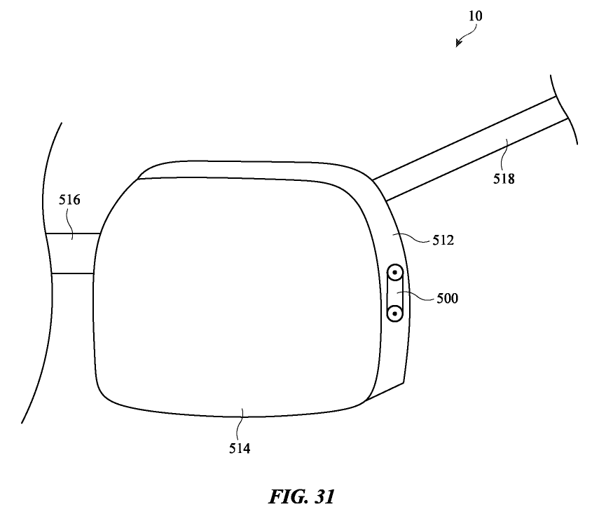

By wrapping SMA wire 510 around pulleys 502A and 502B, a sufficient length of SMA wire 510 may be included to adjust tunable lens 72-2, but the size of SMA wire 510 (and therefore tunable lens 72-2 and/or device 10) may be reduced (e.g., because the lateral size of pulley system 500 is less than the length of travel of tunable lens 72-2). In general pulley system 500 may be incorporated in any suitable portion of device 10. For example, pulley system 500 may be incorporated into a temple of device 10, a side of a frame of device 10, a top or bottom portion of the frame of device 10, or any other suitable location in device 10. An illustrative example in which pulley system 500 is incorporated into a side of a frame of device 10 is shown in FIG. 31.

As shown in FIG. 31, a lens, such as lens 514, may be formed in frame 512 of device 10. Lens 514 may be, for example, tunable lens 72-2. Frame 512 may include other components, if desired, such as additional lenses, displays, optical components, or input-output components, as examples. Temple 518 may be coupled to frame 512 (e.g., to support device 10 on a user’s ear). Frame 512 may include nose bridge 516 (e.g., between first and second lenses of device 10).

Pulley system 500 for SMA wire 510 may be formed in/on a side of frame 512, as shown in FIG. 31. Therefore, SMA wire 510 may be able to adjust lens 72-2, and the compact size of pulley system 500 may reduce the size of device 10.

Although pulley system 500 is shown on the side of frame 512, this is merely illustrative. In some embodiments, pulley system 500 may be formed in temple 518 (e.g., along a length of an arm of device 10) or on a top or bottom portion of frame 512. As an illustrative example, device 10 may include two pulley systems 500, one in each temple 518. Alternatively or additionally, multiple pulley systems 500 may be incorporated into device 10 (e.g., one pulley system 500 per lens or multiple pulley systems 500 per lens).

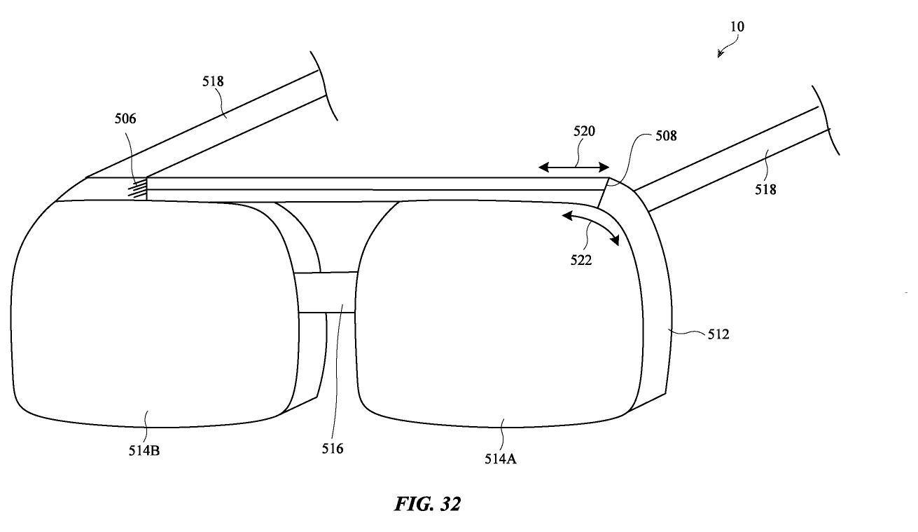

Alternatively or additionally to wrapping SMA wire 510 around a pulley system, SMA wire 510 may be routed along an upper portion of frame 512 over nose bridge 516. An illustrative example is shown in FIG. 32.

As shown in FIG. 32, SMA wire 510 may extend across a top of frame 512 over nose bridge 516. In particular, SMA wire 510 may adjust lens 514A, but may overlap both lens 514B and 514A. SMA wire 510 may move end 508 in directions 520 to adjust lens 514A. Alternatively or additionally, SMA wire 510 (and/or one or more additional SMA wires in device 10) may perform global adjustments of the actuation points of lens 514A in directions 522.

By routing SMA wire 510 across frame 512, overlapping nose bridge 516, SMA wire 510 may adjust lens 514A without being routed through a hinge between frame 512 and temple 518.

Although not shown in FIG. 32, an SMA wire to adjust lens 514B may similarly be routed across the top of frame 512 and may overlap lens 514A, nose bridge 516, and lens 514B. Alternatively or additionally, SMA wire 510 may be wrapped around one or more pulleys (e.g., pulley system 500 of FIGS. 30 and 31) to reduce the lateral footprint of SMA wire 510.

One or more of the actuator designs described herein may be designed to have zero power hold capabilities (where the vertical displacement of the lens shaper is constant even when the actuator is not consuming power).

In the examples herein where an SMA wire is used to selectively displace a component, an alternate actuation method may instead optionally be used to selectively displace the component. For example, the SMA wire 310 from FIG. 8B may instead be a non-SMA wire that is controlled by a stepper motor or other desired actuator.

The tunable lenses herein may include any desired permutation of effectors (e.g., actuators 90 including cam structures, pivot structures, wedge-shaped structures, flexures, etc.), transmissions (e.g., components such as wires, belts, chains, rings, etc. for transferring displacement between different components), and actuators (e.g., SMA wires, electromagnetic motors, ultrasonic motors, etc.).

Additionally, regardless of the effectors, transmissions, and/or actuators included in a tunable lens (e.g., tunable lens 72-2), the tunable lens shaper elements may be calibrated. For example, lens shaping elements (e.g., lens shaping elements 88 and/or tabs 88E) of the tunable lens may be calibrated to have the heights corresponding to a nominal desired optical power of the lens. The heights of lens shaping elements 88 and/or tabs 88E and/or components that directly interface with these parts may be calibrated using additive or subtractive manufacturing, laser welds, active alignment stages with ultraviolet (UV) cured adhesive, and/or any other calibration mechanisms.

The foregoing is merely illustrative and various modifications can be made to the described embodiments. The foregoing embodiments may be implemented individually or in any combination.

What is claimed is:

1. A tunable lens comprising:
a lens element having a periphery;
a lens shaping element attached to the periphery of the lens element; and
a plurality of actuators distributed around the periphery, wherein each actuator in the plurality of actuators is configured to adjust a position of the lens shaping element in a first direction, wherein each actuator in the plurality of actuators comprises a wedge-shaped structure that is configured to move along a second direction that is different than the first direction, and wherein the wedge-shaped structure of each one of the plurality of actuators is controlled by a common wire.

2. The tunable lens defined in claim 1, wherein the common wire is a first common wire, wherein each actuator in the plurality of actuators comprises an additional wedge-shaped structure that is configured to move along the second direction, and wherein the additional wedge-shaped structure of each one of the plurality of actuators is controlled by a second common wire.

3. The tunable lens defined in claim 2, further comprising:
a chassis having a plurality of integral tapered portions, wherein the wedge-shaped structure for each actuator rests on a respective integral tapered portion of the plurality of integral tapered portions and wherein the additional wedge-shaped structure for each actuator rests on the wedge-shaped structure for that actuator.

4. The tunable lens defined in claim 3, wherein each actuator comprises a tapered structure that is interposed between the additional wedge-shaped structure and the lens shaping element.

5. The tunable lens defined in claim 4, wherein the tapered structure is constrained from moving along the second direction and is not constrained from moving along the first direction.

6. The tunable lens defined in claim 1, wherein the wedge-shaped structure of a first actuator of the plurality of actuators has a first tapered surface with a first taper angle, wherein the wedge-shaped structure of a second actuator of the plurality of actuators has a second tapered surface with a second taper angle, and wherein the second taper angle is greater than the first taper angle.

7. The tunable lens defined in claim 1, further comprising:
one or more wire redirecting structures distributed around the periphery, wherein the one or more wire redirecting structures cause bends between linear segments of the common wire.

8. The tunable lens defined in claim 7, wherein the one or more wire redirecting structures comprises a bearing.

9. The tunable lens defined in claim 7, wherein the one or more wire redirecting structures comprises a pulley.

10. The tunable lens defined in claim 7, wherein the one or more wire redirecting structures comprises a flexure.

11. The tunable lens defined in claim 1, wherein each actuator comprises a crimp connection between the common wire and the wedge-shaped structure and wherein the lens shaping element is interposed between the wedge-shaped structure and the common wire.

12. The tunable lens defined in claim 11, further comprising:
a chassis, wherein the wedge-shaped structure is interposed between the chassis and the lens shaping element.

13. The tunable lens defined in claim 12, wherein the wedge-shaped structure of each one of the plurality of actuators is controlled by an additional common wire, wherein each actuator comprises an additional crimp connection between the additional common wire and the wedge-shaped structure, and wherein the chassis is interposed between the wedge-shaped structure and the additional common wire.

14. The tunable lens defined in claim 1, wherein the common wire is a common shape memory alloy (SMA) wire.

15. The tunable lens defined in claim 14, wherein the SMA wire is wrapped around first and second pulleys of a pulley system.

16. A tunable lens comprising:
a lens element having a periphery;
a lens shaping element attached to the periphery of the lens element; and
a rotating ring having a plurality of recesses distributed around the periphery, wherein the rotating ring is configured to rotate along a first direction, wherein each one of the plurality of recesses is configured to adjust a position of the lens shaping element in a second direction that is different than the first direction, and wherein at least two of the plurality of recesses have different shapes.

17. The tunable lens defined in claim 16, wherein the lens shaping element comprises a plurality of integral protrusions and wherein each one of the plurality of integral protrusions is configured to mate with a respective one of the plurality of recesses.

18. The tunable lens defined in claim 16, wherein the lens shaping element is attached to a structure with a plurality of protrusions and wherein each one of the plurality of protrusions is configured to mate with a respective one of the plurality of recesses.

19. The tunable lens defined in claim 16, wherein the rotating ring has integral teeth that mate with a worm gear and wherein the worm gear is configured to selectively rotate the rotating ring along the first direction.

20. The tunable lens defined in claim 16, further comprising:
three set screws attached to the lens shaping element and distributed around the periphery.

21. The tunable lens defined in claim 16, further comprising:
an additional rotating ring that is configured to rotate along a third direction that is opposite the first direction, wherein the rotating ring has integral teeth that mate with a first worm gear on a shaft and wherein the additional rotating ring has additional integral teeth that mate with a second worm gear on the shaft.

22. The tunable lens defined in claim 16, further comprising:
one or more ultrasonic motors that is configured to rotate the rotating ring, wherein the one or more ultrasonic motors is interposed between the rotating ring and a chassis.

23. A tunable lens comprising:
a lens element having a periphery;
a lens shaping element attached to the periphery of the lens element;
a chassis; and
flexures distributed around the periphery, wherein each flexure has first and second opposing ends, wherein the first end of each flexure is attached to the chassis and wherein the second end of each flexure is attached to the lens shaping element; and
a common wire that is configured to displace the second ends of the flexures along a first direction and wherein the displacement of the second ends of the flexures along the first direction causes displacement of the second ends of the flexures along a second direction that is different than the first direction.

24. The tunable lens defined in claim 23, further comprising:
a common ring that attaches the second ends of the flexures and the lens shaping element.

25. A head-mounted device, comprising:
a frame including a nose bridge;
a temple coupled to the frame;
a pulley system coupled to the frame; and
a tunable lens in the frame, wherein the tunable lens comprises:
a lens element having a periphery,
a lens shaping element attached to the periphery of the lens element and
a plurality of actuators distributed around the periphery, wherein each actuator in the plurality of actuators is configured to adjust a position of the lens shaping element, each one of the plurality of actuators is controlled by a common wire, and the common wire is wrapped around the pulley system.

26. The head-mounted device of claim 25, wherein the pulley system is coupled to the frame at a side portion of the frame.

27. The head-mounted device of claim 25, wherein the pulley system is coupled to the temple.

28. The head-mounted device of claim 25, wherein the common wire is coupled to a top portion of the frame and overlaps the nose bridge and the tunable lens.
